(19) United States
(12) Patent Application Publication
(10) Pub. No.: US 2007/0219959 A1
(43) Pub. Date: Sep. 20, 2007

(54) Computer product, database integration reference method, and database integration reference apparatus

(75) Inventor: Yasuhiko Kanemasa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/487,572

(22) Filed: Jul. 17, 2006

(30) Foreign Application Priority Data
Mar. 20, 2006 (JP) 2006-077649

(51) Int. Cl. G06F 17/30

(52) U.S. Cl. 707/3

(57) ABSTRACT

The database integration reference apparatus stores therein metadata for integration which defines the structure of the XML file used for outputting the query result, the correspondence relationship between the elements in the XML file and the elements in the databases, and the correspondence relationship among the elements in different databases. Using the metadata for integration, pieces of data that are distributed in a plurality of databases including an XML-DB and an RDB are integrated so that the user recognizes the distributed data as one virtual XML file. A query that is made to the integrated data and is written in an XML query language called XQuery is received, and a piece of integrated data is extracted in an XML format and output to the user terminal.

### BACKGROUND OF THE INVENTION

1. Field of the Invention

The present invention relates to a distributed database systems in which pieces of data are distributed in a plurality of databases.

2. Description of the Related Art

In recent years, distributed database systems in which pieces of data are distributed in a plurality of databases have been employed to distribute the load and reduce risk of loss of data. Specifically, if the pieces of data are distributed in various databases, the load caused by concentration of queries can be distributed. Moreover, if any failure occurs, only some of the databases will fail, so that data in other databases is safe.

Although the data is distributed; however, the distributed database system offers a function that, when the data needs to be referenced, the databases can be used as if they were a single database. As a method to realize such a function, for example, Japanese Patent Application Laid-open No. 2005-208757 discloses a technique by which the data distributed in a plurality of Relational Databases. (RDBs) is integrated into an integrated data view in a tagged document format, and a query based on an integrated reference to the RDBs is made possible through execution of a query made to the integrated data view.

However, there is a wide variety of available databases, and there are some databases that are different from RDBs, which have conventionally been used. For example, there is an Extensible Markup Language Database (XML-DB) in which data is stored in an Extensible Markup Language (XML) format. Accordingly, a distributed database system may be configured so as to include a database, like an XML-DB, that is different from RDBs.

In such an XML-DB, because the schema is indefinite or semi-fixed, the schema of the integrated data view defined based on the schema is also indefinite. On the other hand, the schemas in RDBs are strictly definite. For this reason, even if the conventional technique disclosed in, for example, Japanese Patent Application Laid-open No. 2005-208757 is used, a problem remains where it is impossible to perform a query processing using the integrated data view on a group of databases including both an XML-DBs and an RDB, because of the characteristic that the schema of the integrated data view may be indefinite.

As explained above, because there are a wide variety of databases and because the types of databases in which data is distributed are different from one another, the problem arises where it is impossible to perform a query processing using an integrated data view.

Further, the schema of the data stored in an XML-DB does not necessarily coincide with the schema of the integrated data view that the user wishes to use. There is a possibility that, if XML document data obtained from an XML-DB is applied to an integrated data view as it is, it is not possible to provide a user with an integrated data view that the user wishes to use.

### SUMMARY OF THE INVENTION

It is an object of the present invention to at least partially solve the problems in the conventional technology.

According to an aspect of the present invention, a computer-readable recording medium that stores therein a computer program that causes a computer to reference pieces of data that are distributed in a plurality of different types of databases including a database that returns a query result as data that is uniquely identified in a hierarchical structure, by outputting, in an integrated view, a query result obtained as a result of queries that are made, in query formats, to the databases causes the computer to execute storing a view generation rule for generating the integrated view that is defined by a correspondence relationship between elements in the data that is uniquely identified in the hierarchical structure and elements in the databases and a correspondence relationship among the elements in the databases; and structuring, based on the view generation rule, the query result obtained as the result of the queries that are made, in the query formats, to the databases, in response to a query that is made, in a query format, to the integrated view.

According to another aspect of the present invention, a computer-readable recording medium that stores therein a computer program that causes a computer to reference pieces of data that are distributed in a plurality of different types of databases including a tagged document database that returns a query result as a tagged document of which a structure is predetermined, by outputting, in an integrated view, a query result obtained as a result of queries that are made, in query formats, to the databases causes the computer to execute storing a view generation rule for generating the integrated view that is defined by a correspondence relationship between elements in the tagged document and elements in the databases and a correspondence relationship among the elements in the databases; and structuring, based on the view generation rule, the query result obtained as the result of the queries that are made, in the query formats, to the databases, in response to a query that is made, in a query format, to the integrated view.

According to still another aspect of the present invention, a database integration reference method of referencing pieces of data that are distributed in a plurality of different types of databases including a database that returns a query result as data that is uniquely identified in a hierarchical structure, by outputting, in an integrated view, a query result obtained as a result of queries that are made, in query formats, to the databases, includes storing a view generation rule for generating the integrated view that is defined by a correspondence relationship between elements in the data that is uniquely identified in the hierarchical structure and elements in the databases and a correspondence relationship among the elements in the databases; and structuring, based on the view generation rule, the query result obtained as the result of the queries that are made, in the query formats, to the databases, in response to a query that is made, in a query format, to the integrated view.

According to still another aspect of the present invention, a database integration reference apparatus that makes it possible to reference pieces of data that are distributed in a plurality of different types of databases including a tagged document database that returns a query result as a tagged document of which a structure is predetermined, by outputting, in an integrated view, a query result obtained as a result of queries that are made, in query formats, to the databases, includes a storage unit that stores therein a view generation rule for generating the integrated view that is defined by a correspondence relationship between elements in the tagged document and elements in the databases and a correspondence relationship among the elements in the databases; and a processing unit that structures, based on the view generation rule present in the storage unit, the query result obtained as the result of the queries that are made, in the query formats, to the databases, in response to a query that is made, in a query format, to the integrated view.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a drawing for explaining the overview and the characteristics of a database integration reference system according to a first embodiment of the invention;

FIG. 2 is a drawing for explaining the overview and the characteristics of the database integration reference system according to the first embodiment;

FIG. 3 is a system configuration diagram of an overall configuration of the database integration reference system according to the first embodiment;

FIG. 4 is a drawing of an exemplary configuration of information stored in databases shown in FIG. 3;

FIG. 5 is a drawing of an example of mapping of the database data onto an XML;

FIG. 6 is a drawing of an example of metadata for integration (in particular, virtual XML schema information);

FIG. 7 is a drawing of an example of metadata for integration (in particular, database information (1));

FIG. 8 is a drawing of an example of metadata for integration (in particular, database information (2));

FIG. 9 is a drawing of an example of metadata for integration (in particular, information for associating elements);

FIG. 10 is a flowchart of the procedure in a query processing;

FIG. 11 is a drawing of a specific example of the procedure in a query processing;

FIG. 12 is a drawing of a specific example of the procedure in a query processing;

FIG. 13 is a drawing of a specific example of the procedure in a query processing;

FIG. 14 is a drawing of a specific example of the procedure in a query processing;

FIG. 15 is a drawing of a specific example of the procedure in a query processing;

FIG. 16 is a drawing of a specific example of the procedure in a query processing;

FIG. 17 is, a drawing of a specific example of the procedure in a query processing;

FIG. 18 is a drawing of a specific example of the procedure in a query processing;

FIG. 19 is a drawing for explaining the characteristics of the first embodiment;

FIG. 20 is a drawing for explaining a first characteristic of a second embodiment of the invention;

FIG. 21A and 21B are drawings for explaining a second characteristic of the second embodiment;

FIG. 22 is a drawing for explaining a third characteristic of the second embodiment;

FIG. 23 is a drawing for explaining a fourth characteristic of the second embodiment;

FIG. 24 is a drawing for explaining a fifth characteristic of the second embodiment; and

FIG. 25 is a drawing for explaining a sixth characteristic of the second embodiment.

### DETAILED DESCRIPTION OF THE PREFERRED EMBODIMENTS

Exemplary embodiments of the present invention will be explained in detail below with reference to the accompanied drawings. In the exemplary embodiments described below, the present invention is applied to a database integration reference program, a database integration reference method, and a database integration reference apparatus that integrate an Extensible Markup Language Database (XML-DB) with a Relational Database (RDB) in such a manner that it is possible to reference these databases, where a tagged document is used as an XML document. In the following description, a database and databases may be referred to as a DB and DBs.

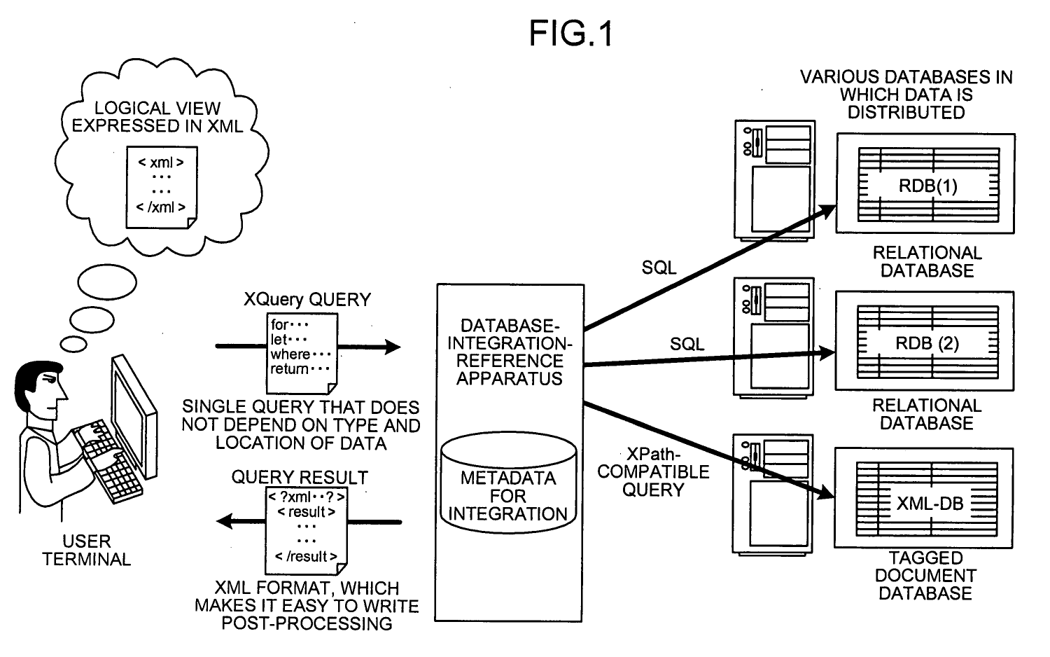

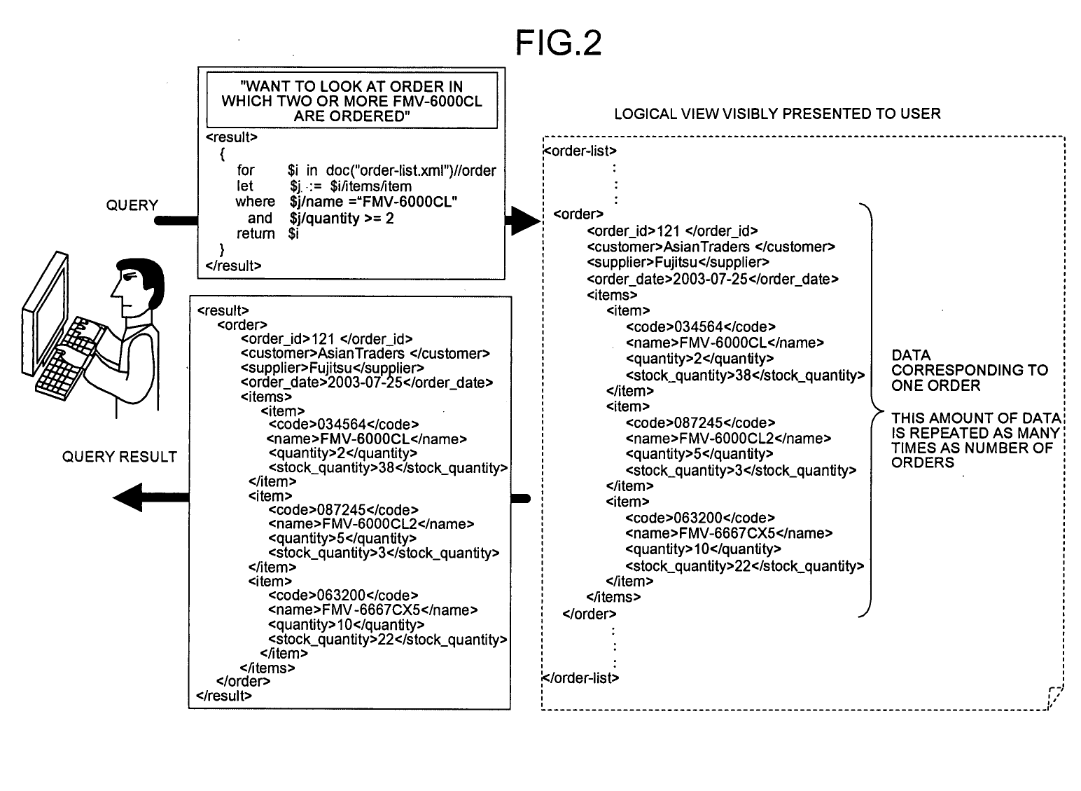

Firstly, the overview and the characteristics of a database integration reference system according to a first embodiment of the invention will be explained with reference to FIG. 1 and FIG. 2. FIG. 1 and FIG. 2 are drawings for explaining the overview and the characteristics of the database integration reference system according to the first embodiment.

As shown in FIG. 1, the database integration reference system according to the first embodiment is configured so as to include a database integration reference apparatus that intervenes between a plurality of databases including an XML-DB and RDBs (RDB(1), RDB(2), and the XML-DB) and a user terminal. Schematically, the database integration reference apparatus receives, from the user terminal, queries for data reference that are made to the plurality of databases, obtains data related to the queries from corresponding ones of the databases, and returns the query results to the user terminal.

In this system, as shown in FIG. 1 and FIG. 2, the database integration reference apparatus integrates the data distributed in the databases, using the metadata for integration and enables the user to recognize the integrated data as a virtual XML document (for example, an XML file). The database integration reference apparatus also receives a query (for example, a query written in an XML query language called “XQuery”) for data reference that is made to the integrated data in a query format corresponding to an XML document and takes out a piece of integrated data in an XML format.

To be more specific, the database reference apparatus structures an integration query engine for providing data from the integrated databases in an XML model and handles the data distributed in the databases as an XML file. Thus, the database reference apparatus realizes a data view integration on the apparatus side.

With the database integration reference apparatus according to the first embodiment having the configuration described above, it is possible to achieve, for example, real-time data access, a remarkable reduction in man-hours for the development of upper-level applications, a database integration having a high level of flexibility and extensibility, and a step-by-step metadata structuring, which are described below.

According to the first embodiment, the distributed data is not physically gathered in one place like a data warehouse (DWH), but the data remains to be distributed in the existing databases. When a query is made, only necessary data is obtained, and as a result, an integrated data view is generated. With this arrangement, it is possible to achieve real-time data access.

In addition, according to the first embodiment, the distributed data is integrated into a file in an XML format. A query is made to the XML file, using XQuery, and it is possible to take out the query result also in an XML format. In other words, it is possible to provide a data view that is integrated in an XML file, to the upper-level application side. Thus, there is no need to put a function for data view integration into the upper-level application side. Accordingly, it is possible to remarkably reduce the man-hour for development of the upper-level applications.

Also, according to the first embodiment, the data in the databases including the XML-DB and the RDBs is eventually integrated into the data view in the XML file after a model conversion. Because such an XML file format has a high level of flexibility and extensibility, it is possible to use the integrated XML file in a flexible manner. To be more specific, because the data view according to the first embodiment is integrated using an XML, it is possible to, for example, easily structure not only a search system but also various application systems that are compatible with the XML, on the system according to the first embodiment. Thus, it is possible to integrate the databases with a high level of flexibility and extensibility.

Further, according to the first embodiment, the metadata for integration is used to define, with flexibility, what data view is structured from the pieces of distributed data. During this operation, it is possible to make the definition only with the information that is necessary for the queries. With this arrangement, there is no need to define all the pieces of information at the beginning. Thus, it is possible to structure the metadata for integration in a step-by-step manner.

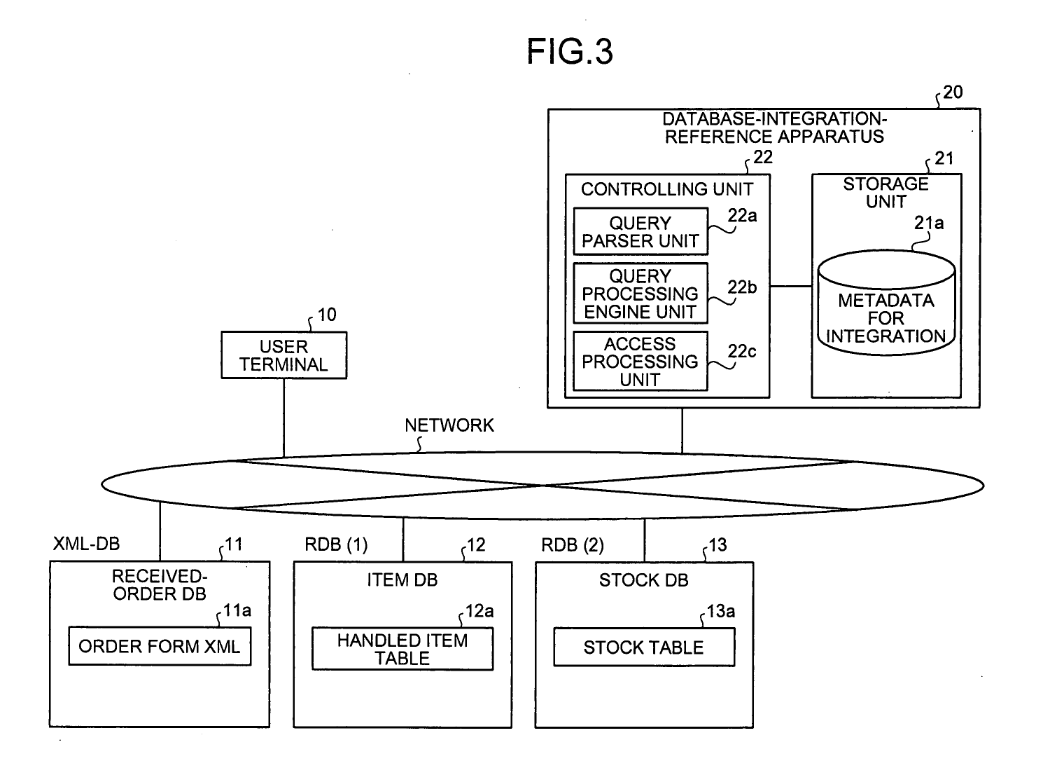

Next, the overall configuration of the database integration reference system according to the first embodiment will be explained. FIG. 3 is a system configuration diagram of the overall configuration of the database integration reference system according to the first embodiment. As shown in the drawing, the database integration reference system according to the first embodiment includes a user terminal 10, a plurality of databases (i.e. an XML-DB that is a received-order DB 11, an RDB (1) that is an item DB 12, and an RDB (2) that is a stock DB 13), and a database integration reference apparatus 20 that are connected to one another in such a manner that communication is allowed, via a network such as a Local Area Network (LAN) or the Internet.

The databases in this system are such databases that are integrated according to the first embodiment. According to the first embodiment, the received-order DB 11 is an XML-DB, whereas the item DB 12 and the stock DB 13 are RDBs. In the description of the first embodiment, as shown in FIG. 3, an example in which the data is distributed in the three databases, namely, the received-order DB 11, the item DB 12, and the stock DB 13 will be explained.

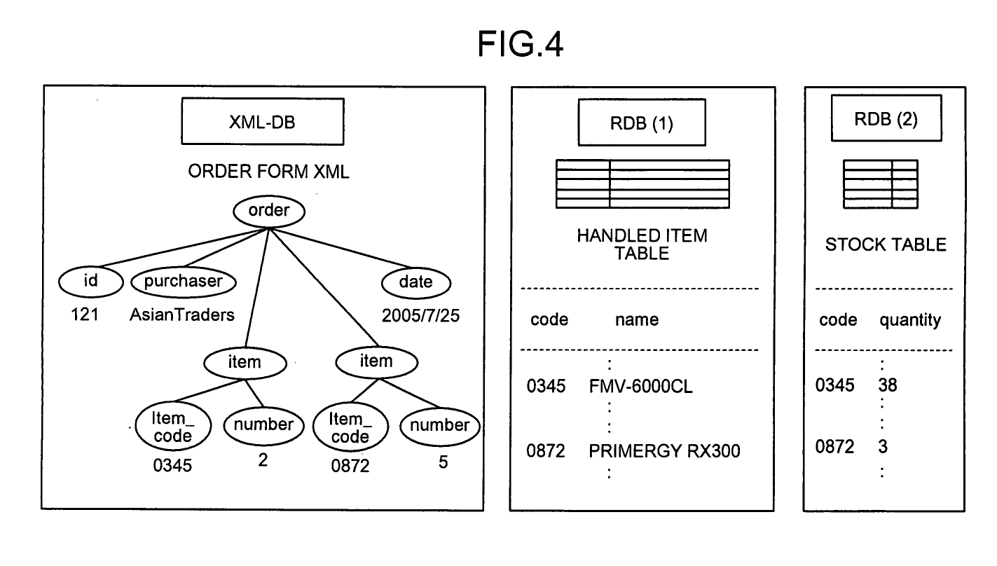

In this example, the received-order DB 11 is a database that stores therein the information related to the orders received by a corporation. As shown in FIG. 4, an order form XML11a stored in the database is structured so as to have a tree structure in which “order (an order)” has pieces of data representing the elements such as “id (an order ID)”, “purchaser (the purchaser)”, “item (the name of the item)”, and “date (the year-month-day on which the order is received)” as its subordinates. Also, the order form XML 11a is structured so as to have a tree structure in which “item” under “order” has pieces of data representing the elements such as “item_code (the item code)” and “quantity (the quantity specified in the received order)”. With this arrangement, each tree structure positioned as the subordinate of an “order” corresponds to a record of a received order that is equivalent of one order form. One order may include a plurality of items that are ordered. Thus, in one record of order form XML 11a, a sub-tree structured with “item” having “item code” and “quantity” as its subordinates may appear repeatedly.

The item DB 12 is a database that stores therein the information related to items that are handled by the corporation. As shown in FIG. 4, a handled item table 12a stored in the database is structured so as to include, for each of the handled items, pieces of data that represent the elements such as “code (the item code)” and “name (the name of the item)” and are in correspondence with each other.

The stock DB 13 is a database that stores therein the information related to the stock of the handled items. As shown in FIG. 4, the stock table 13a stored in the database is structured so as to include, for each of the handled items, pieces of data that represent the elements such as “code (the item code)” and “quantity (the stock quantity)” and are in correspondence with each other.

In the order form described above, the types of items are expressed only with the item codes; however, when people look at order forms, it is easier to understand when the names of the items are displayed. Thus, when the user wishes to convert the item codes in the order forms into the names of the items, using the handled item table 12a stored in the item DB 12, it is advantageous to use the database integration reference system according to the first embodiment.

Also, when the user processes an order while looking at the order form, if the user wishes to check the stock by having the stock quantity displayed at the same time, it is advantageous to use the database integration reference system according to the first embodiment. (In this situation, the stock quantity of each item is obtained from the stock DB. Because the stock quantity of each item is stored in the stock DB 13, it is necessary to make queries to both about the stock quantity.)

As explained so far, when the user wishes to reference data that is related to one order and is distributed in the three databases, as one piece of collective data, it is advantageous to use the database integration reference system according to the first embodiment.

Returning to the description of FIG. 3, the user terminal 10 is a terminal used by a user to make a query for data reference to the plurality of databases via the database integration reference apparatus 20. The user terminal 10 may be configured with a personal computer, a work station, a personal digital assistant (PDA), or a mobile communication terminal such as a portable phone or a personal handyphone system (PHS), all of which are based on the techniques that are publicly known.

As shown in FIG. 1 and FIG. 2, the main functions of the user terminal 10 include a function to allow a user to input a query written in an XML query language called “XQuery” (i.e. an XQuery query) via a keyboard or a mouse, a function to transmit the input XQuery query to the database integration reference apparatus 20, a function to receive a query result in an XML format from the database integration reference apparatus 20, and a function to output the received query result on a monitor or the like.

As shown in FIG. 2, when the database integration reference system according to the first embodiment is used, it appears to the user as if the information related to each order was collected together and was enclosed by “order” tags, and as if all the orders were arranged in a row and stored in one large XML file. This is, however, merely a logical view. The substance of the data is only inside the databases. When the user makes a query to the database integration reference apparatus 20, pretending that the logical view exists, the XML document data that corresponds to a particular order is returned.

Returning to the description of FIG. 3, the database integration reference apparatus 20 is a server computer that is based on a publicly-known technique and processes a query for data reference received from the user terminal 10. The main functions of the database integration reference apparatus 20 include a function to receive an XQuery query from the user terminal 10, a function to obtain data related to the query out of the databases and to generate an XML query result, and a function to transmit the generated XML query result to the user terminal 10. Next, the configuration of the database integration reference apparatus 20, which offers principal characteristics of the first embodiment, will be explained in detail.

The database integration reference apparatus 20 is configured so as to include, as shown in FIG. 3, a storage unit 21 and a controlling unit 22. Of these, the storage unit 21 is a unit that stores therein data and programs that are necessary for various types of processing performed by the controlling unit 22. In particular, as data that is closely related to the present embodiment, metadata for integration 21a is stored in a repository, as shown in FIG. 3.

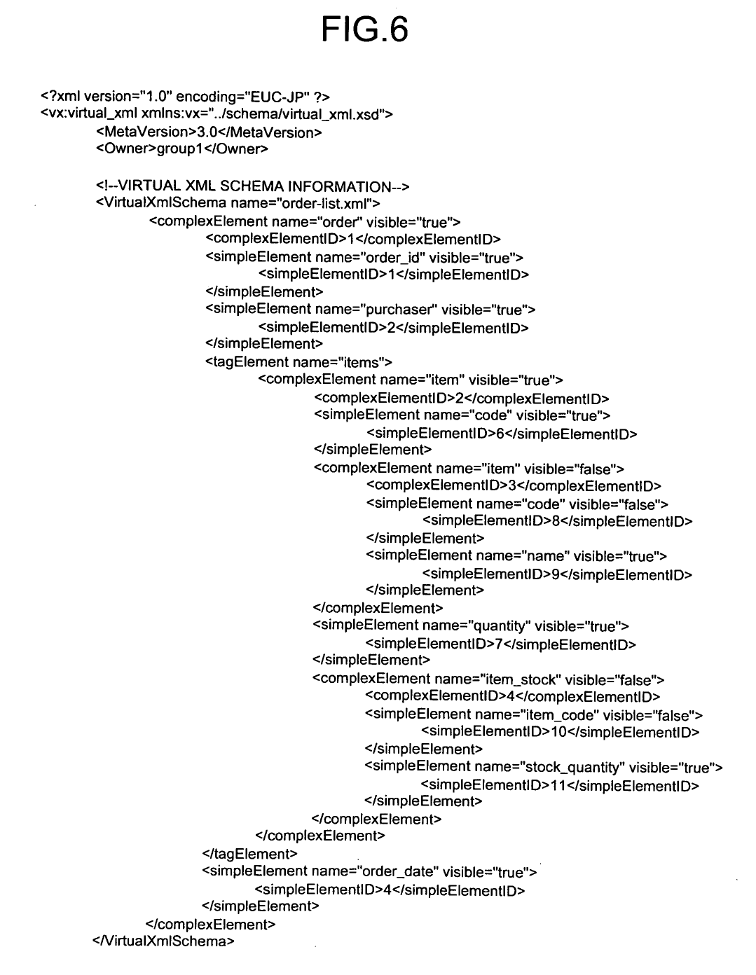

In the metadata for integration 21a, the information that is necessary for the integration of the databases is defined. To be more specific, as shown in FIGS. 6 through 9, the metadata for integration 21a is configured so as to include virtual XML schema information, database information (1), database information (2), and information for associating elements.

To describe it more in detail, the virtual XML schema information defines, as shown in FIG. 6, information indicating in what format of XML document data, the relevant data existing in more than one databases is visibly presented to the user.

The virtual XML schema information is explained more specifically, with reference to FIG. 6. The virtual XML schema information defines the XML structure of the integrated data view, using a format that is similar to the XML schema. There are three kinds of nodes, namely, A1, A2, and A3, that are used for structuring the schema, as described below.

A1: Complex Element

A Complex Element is an intermediate node that has one or more other nodes as its subordinates. When the corresponding database is an RDB, a set that is made up of a Complex Element and one or more Simple Elements being its subordinates corresponds to one record in a database. When the corresponding database is an XML-DB, a Complex Element is an intermediate node that has one or more other nodes as its subordinates, and the Complex Element itself has no value. A Complex Element has attributes as listed below. Any of the three types of nodes, namely, a Complex Element, a Simple Element, and a Tag Element may appear as a subordinate of a Complex Element.
Name: the tag name of the node in the integrated data view Visible or Invisible: Whether it should be displayed in the integrated data view
Maximum number of appearances: the upper limit of the number of times the node appears repeatedly
Minimum number of appearances: the lower limit of the number of times the node appears repeatedly
Dummy designation: when the corresponding database is an XML-DB, whether the node is a node that does not actually exist in the XML data
   A2: Simple Element

A Simple Element is a terminal node that has a value as its subordinate. When the corresponding database is an RDB, a Simple Element corresponds to one column in a record and holds only its value. When the corresponding database is an XML-DB, a Simple Element corresponds to a terminal node having a value. A Simple Element has attributes as listed below. Because a Simple Element is a terminal node, no other node can be a subordinate of a Simple Element. Name: the tag name of the node in the integrated data view Visible or Invisible: Whether it should be displayed in the integrated data view
Schemaless designation: When the corresponding database is an XML-DB, whether a flexible schema is allowed to appear as its subordinate, by treating all the tags appearing as the subordinates of the node as a mere character string
   A3: Tag Element

A Tag Element is a dummy node used for inserting a tag and does not have a corresponding database element. A Tag Element has an attribute such as “Name: the tag name of the node in the integrated data view”. Any of the three types of nodes, namely, a Complex Element, a Simple Element, and a Tag Element may appear as a subordinate of a Tag Element.

A unique ID is given to each Complex Element and each Simple Element so that the correspondence relationship between the node and the corresponding database element can be understood. The unique IDs are called a Complex Element-ID and a Simple Element-ID, respectively. When the corresponding database is an RDB, a set made up of a Complex Element and one or more Simple Elements corresponds to one record in the RDB. A tree structure is constructed by connecting such sets to one another. When the sets are connected, it is necessary to have an entry that makes an association (i.e. matching of the values) between the sets.

Regardless of this arrangement, it is possible to insert a Tag Element at a place where a dummy tag needs to be added. When the corresponding database is an XML-DB, it is necessary to structure a virtual XML schema in compliance with the schema of the XML data stored in the XML-DB. When a tag that does not exist in the schema of the original XML data needs to be added, a Tag Element is used. When a tag that exists in the schema of the original XML data needs to be deleted, the attribute of the tag for “Visible or Invisible” is set to “False”.

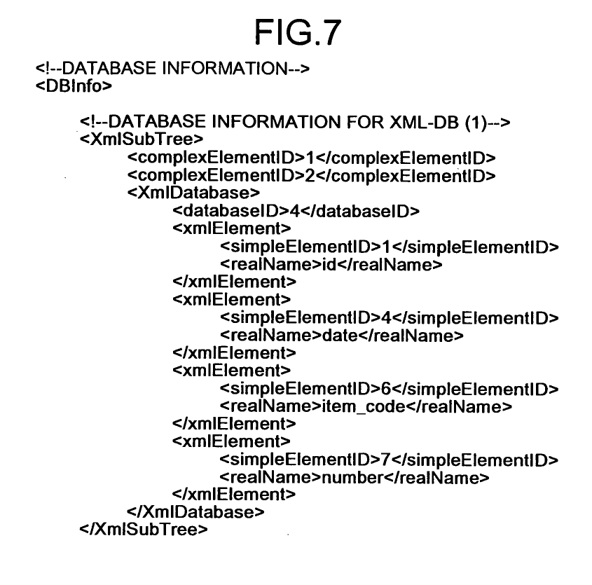

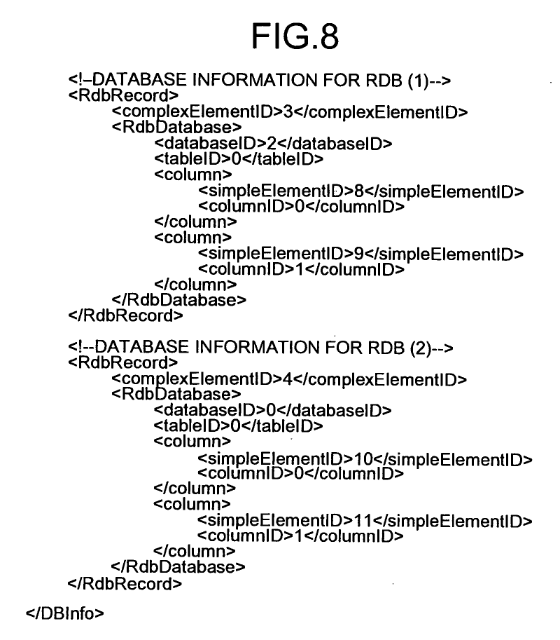

As the database information, as shown in FIG. 7 and FIG. 8, information indicating which element in which database corresponds to each of the elements in the XML (see FIG. 6) is defined. In the database information, it is described which entry in which database actually corresponds to each of the elements (i.e. Complex Element and Simple Element) in the virtual XML schema. The contents of the description largely vary depending on whether the corresponding database is an RDB or an XML-DB. The database name is indicated by an ID in the tag “database ID”. A table showing the correspondence between the IDs and the actual database names is managed separately. The table name is indicated by an ID in the tag “table ID”, and the column name is indicated by an ID in the tag “column ID”. A table showing the correspondence between the IDs and the actual table names as well as the correspondence between the IDs and the column names is managed separately.

When the corresponding database is an RDB, it is described to which table in which RDB, each of the Complex Elements corresponds. It is also described to which column in the table, each of the Simple Elements being subordinate to the Complex Element corresponds.

When the corresponding database is an XML-DB, it is described a sub-tree including which Complex Elements corresponds to which XML-DB data. Further, when the tag name in the data view is different from the tag name in the XML-DB, the correspondence between these tag names is also described. (If there is no description about tag name correspondence for some Complex Elements and Simple Elements, it is assumed that the tag name in the data view is the same as the tag name in the XML-DB.) When the processing target is only a repetitive structure that is a part of a large piece of XML data stored in an XML-DB, the path from the root to the repetitive structure is written here.

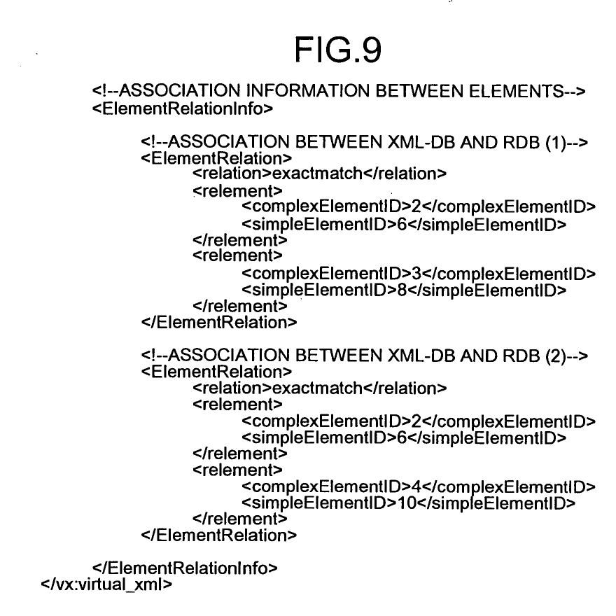

As the information for associating elements, as shown in FIG. 9, when records in mutually different tables are associated with one another to obtain one XML, information indicating which columns in the tables are brought into correspondence (i.e. are associated with each other) is defined.

The information for associating elements describes information for connecting the “sets made up of Complex Elements and Simple Elements” that correspond to RDBs to one another and connecting a “set made up of a Complex Elements and Simple Elements” to an XML sub-tree that corresponds to an XML-DB. To be more specific, it is described using which Simple Element and which Simple Element, the matching of the values is performed. In the first embodiment, the association is made through only one type, which is “a complete match of the values”.

As for the “sets made up of Complex Elements and Simple Elements” that correspond to RDBs, any one of the Simple Elements in the sets can be used for making associations. On the other hand, as for the XML sub-tree that corresponds to an XML-DB, the Simple Elements that can be used for making associations are restricted so that one-to-one correspondence relationship can be ensured. When another database is connected to the lower level, for a Complex Element that is used as a connection point in the virtual XML schema information (i.e. a node that corresponds to the connected database appears as a subordinate of the Complex Element), only the Simple Elements that are the child nodes of the Complex Element can be used for making the associations. When another database is connected to the upper level, only the Simple Elements that are the child nodes of the Complex Element on the uppermost level of the XML sub-tree can be used for making the associations.

When the Simple Elements that can be used for making the associations are restricted, it is inconvenient because the virtual XML views that can be generated are also restricted. Thus, the restriction is mitigated using the number of maximum appearances set for the Complex Element. For example, when the maximum number of appearances for the Complex Element being the connection point is 1, it is possible to enlarge the range of associations to the Simple Elements that are the child nodes of a Complex Element that is positioned adjacent on the upper level in the XML sub-tree. Recursively, as long as the maximum number of appearances for a Complex Element is 1, it is possible to enlarge the range of associations to the Simple Elements that are the child nodes of a Complex Element that is positioned in the next upper level. Conversely, for a Complex Element being the connection point, if the maximum number of appearances for the Complex Element being its subordinate is 1, it is possible to enlarge the range of associations to the Simple Elements that are the child nodes of the Complex Element. It is also possible to enlarge the range of associations recursively for the Complex Elements in the further lower levels.

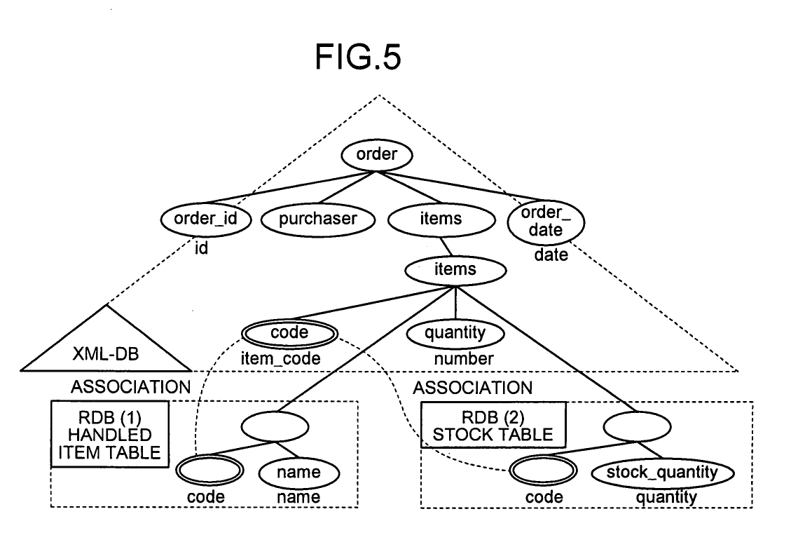

The metadata for integration shown separately in FIGS. 6 through 9 is one piece of metadata for integration and is included in one file in an XML format. The storage unit 21 stores therein, in advance, the metadata for integration 21a like this. Such metadata for integration is generated through a mapping operation (see FIG. 5) performed by a system administrator or the like. In the example of a mapping operation shown in FIG. 5, the data in the three databases shown in FIG. 4 is mapped onto an XML tree structure. When a system administrator or the like performs such a mapping operation, the information having the same contents as the one shown in FIG. 5 is written in the metadata for integration 21a in an XML format. Accordingly, the integrated data is visibly presented to the user as XML document data having the format shown in FIG. 5.

The method (or the rule) for mapping the data in the databases onto an XML tree structure can be described as follows: (1) It appears, to a user, as if a piece of data that is obtained by combining pieces of data from different databases was contained in one XML repeatedly as many times as the number of pieces of data. (2) The pieces of data from the databases to be integrated are mapped onto the XML elements in units of tables. (3) The XML elements that correspond to the tables can be arranged in a hierarchical manner. (4) Of the XML elements that correspond to the tables, the elements that are positioned adjacent to each other, above and below, in the hierarchical structure require that pieces of data that are in the respective corresponding tables should be associated with each other. In other words, one column in each of the tables should have the same value. (5) It is acceptable for a table that corresponds to one XML element to specify a plurality of different tables that are included in different databases. (6) The tag name of an XML that corresponds to a column of a database may be a different name from the column name.

Returning to the description of FIG. 3, the controlling unit 22 included in the database integration reference apparatus 20 is a processing unit that has an internal memory for storing therein a control program such as an operating system (OS), a program that defines various processing procedures, and other necessary data and executes various types of processing using the programs and the data. In particular, as the elements that are closely related to the present invention, as shown in FIG. 3, the controlling unit 22 includes a query parser unit 22a, a query processing engine unit 22b, and an access processing unit 22c.

Of these elements, the query parser unit 22a is a processing unit that, after analyzing and checking the syntax of the XQuery query received from the user terminal 10, converts the contents of the query into an internal format. When the query has a syntax violation, the query parser unit 22a returns an error message indicating the syntax violation to the user terminal 10.

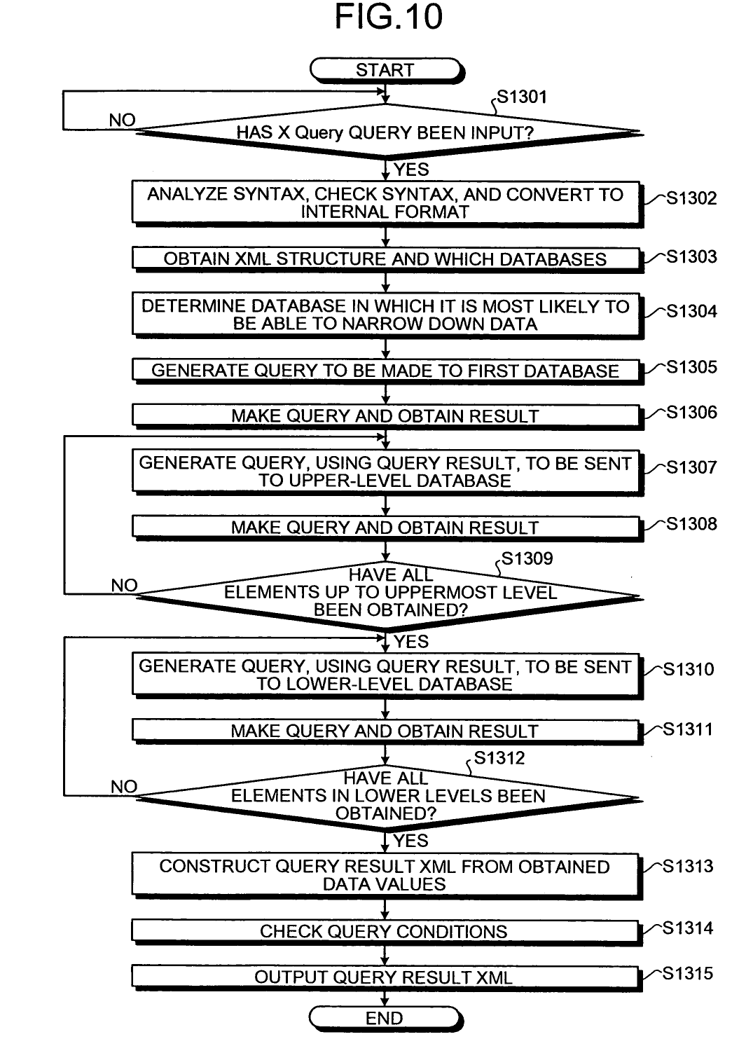

The query processing engine unit 22b is a processing unit that actually processes the XQuery query converted by the query parser unit 22a, obtains data by making necessary queries to the databases accordingly, generates a query result in an XML, and returns the generated query result to the user terminal 10. In other words, the query processing engine unit 22b plans what queries need to be made to the databases in what order so as to obtain the data (i.e. generates a structured query language (SQL) to make queries to the databases) and executes the plan (i.e. sends the generated SQL to the databases and obtains the results). The query processing engine unit 22b then constructs XML document data to be eventually returned to the user terminal 10, using the data obtained from the databases as the query results. The specific contents of the processing performed by the query processing engine unit 22b will be explained more in detail later, with reference to FIG. 10 and the like.

The access processing unit 22c is a processing unit that actually accesses the databases after the query processing engine unit 22b has made query requests to the databases. The access processing unit 22c performs the processing of transmitting, to the corresponding databases, queries that correspond to the databases and that have been generated from the XQuery query converted by the query parser unit 22a.

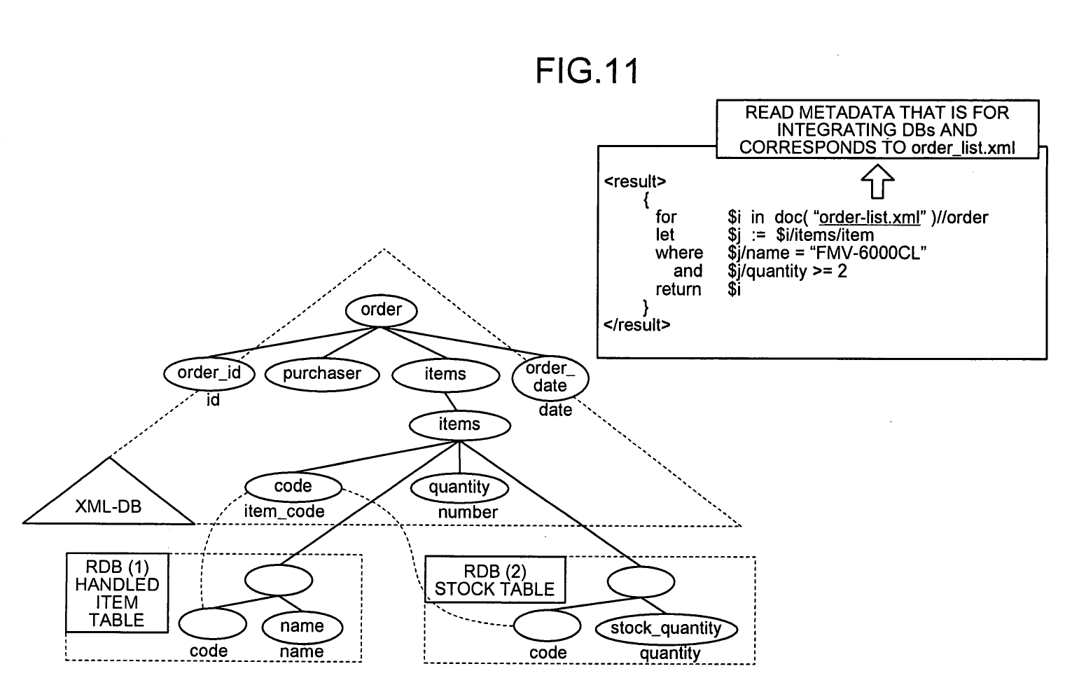

Next, the query processing procedure performed by the database integration reference apparatus 20 will be explained with reference to FIGS. 10 to 18. FIG. 10 is a flowchart of the procedure in the query processing according to the first embodiment. FIGS. 11 through 18 are drawings of specific examples of the procedure in the query processing.

As shown in FIG. 10, when an XQuery query as shown in FIG. 2 is input from the user terminal 10 (step S1301: Yes), the database integration reference apparatus 20 analyzes the syntax of the XQuery query and checks the syntax. Then, the database integration reference apparatus 20 converts the contents of the query into the internal format (step S1302). When the query has a syntax violation, an error message indicating the syntax violation is returned to the user terminal 10.

Subsequently, the database integration reference apparatus 20 reads the metadata for integration that is related to the query from the storage unit 21 and finds out the structure of the XML being the query target and in which databases the data that corresponds to the elements is stored (step S1303).

To be more specific, as shown in FIG. 11, for an XQuery query as shown in FIG. 2, the metadata for integration that corresponds to “order-list.xml” is read from the storage unit 21, so that the structure of the XML and also the databases in which the data corresponding to the elements is stored are found out. Thus, the information that can be expressed in a tree structure as shown in FIG. 11 is obtained.

As a method to optimize the order in which queries are made, the database integration reference apparatus 20 then divides the elements in the XML structure obtained at step S1303 depending on in which database the data is stored, examines the conditional statement specified by the user in the XQuery query, and determines a database in which it is most likely to be able to narrow down the data (step S1304).

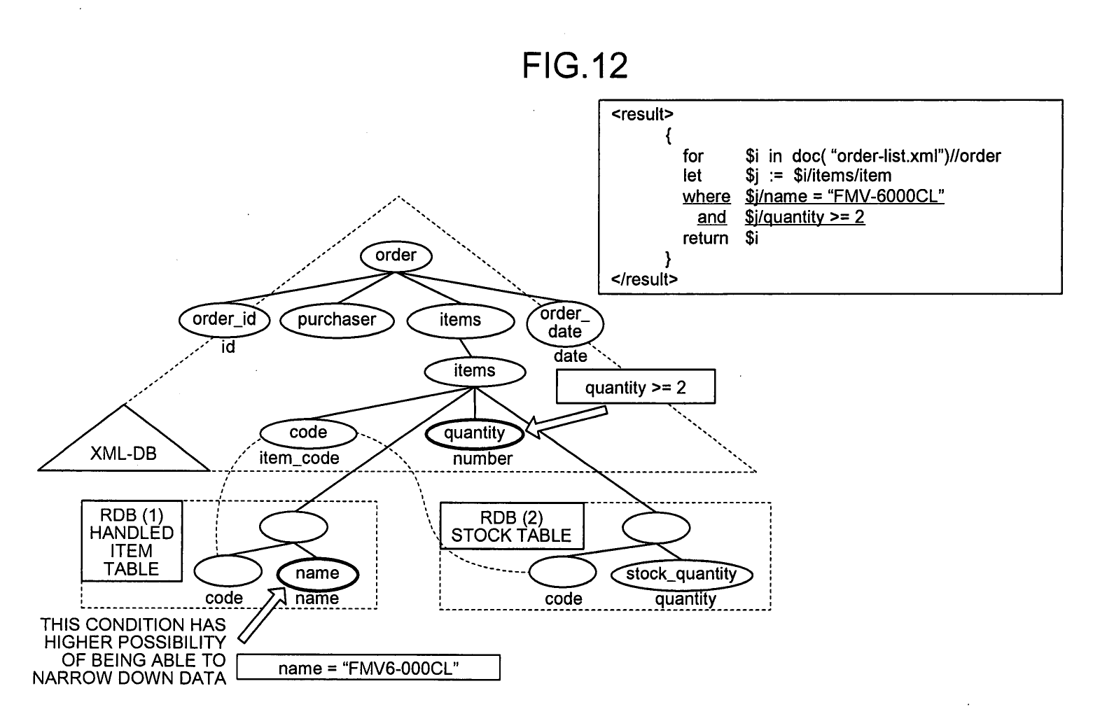

To be more specific, as shown in FIG. 12, between the condition ‘name=“FMV-6000CL””’ and the condition ‘quantity>=2’ that are,included in the XQuery query, it is projected to which one of the item table and the handled item table, a query should be made first so that the data amount of the query result becomes smaller. Thus, it is determined that the query is first made to the table that is projected to offer a smaller amount of data. The drawing shows an example in which it is determined that the query is first made to the handled item table; however, the method to optimize the order in which the queries are made will be explained in detail later.

Subsequently, the database integration reference apparatus 20 generates a query for querying about the data that matches the condition to the first database determined at step S1304 (step S1305). The query generated at this step is generated in a format that corresponds to the type of database being the query target. To be more specific, when the database being the query target is an XML-DB, the query is written in an XPath (or an XPath-compatible query language). When the database being the query target is an RDB, the query is written in an SQL. Next, the generated query is sent to the corresponding database so as to obtain a query result (step S1306). It should be noted, however, that the value obtained from the database at this point in time is only the column associated with an element in the upper level.

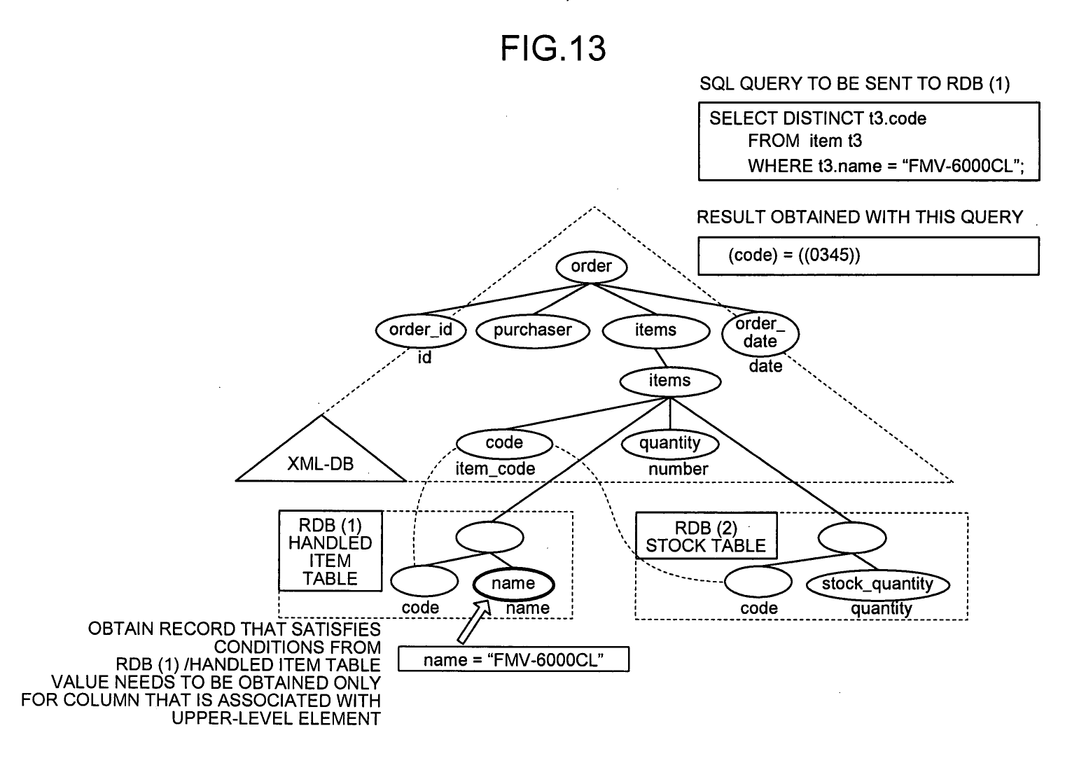

To be more specific, as shown in FIG. 13, an SQL is generated for querying about the data that matches the condition ‘name=“FMV-6000CL”’ to the handled item table in the RDB (1) (i.e. the item DB 12), and the generated SQL is sent to the item DB 12. Thus, a query result that contains ‘code=0345’ as the data that matches the condition is obtained, out of the handled item table in the item DB.

When a sub-query text for an XML-DB is generated using an XPath (or an XPath-compatible query language), firstly, of condition expressions provided in the XQuery executed on the integrated data view, condition expressions that apply conditions on the nodes within the range of the XML sub-tree to which the XML-DB being the target corresponds are selected. Secondly, the XPath is generated according to the paths in the XML sub-tree, based on the selected condition expressions. This operation is only to convert the XQuery into the XPath, except that substitutions of paths occur due to the change of the position of the root.

When there are a plurality of condition expressions in the XQuery, and the variable used in the paths in the condition expressions is bound to a node outside the range of the XML sub-tree being the target, there are some cases where it is not possible to put the condition expressions together using one XPath. In such a case, the XPath is constructed using only some of the condition expressions with which it is likely to be able to narrow down the data, without using some other condition expressions.

Subsequently, the database integration reference apparatus 20 generates a query for sequentially finding out the upper-level elements in the XML tree structure, using the result of the previous queries to the databases (step S1307). The method of selecting the query type is the same as the one used at step S1305. The generated query is sent to the corresponding database, and a query result is obtained (step S1308). The processing at steps S1307 and S1308 is repeatedly performed until the element in the uppermost level in the XML tree structure is obtained, by sequentially obtaining the values of pieces of data that correspond to the elements in an upper level each time, starting from the element at which the query to the databases has begun (step S1309).

In this processing, the association with the previous query result is used as the condition to narrow down the data, and also if there are other conditions specified by the user in the XQuery query, those conditions are also added to the conditions used to narrow down the data. The values obtained from the databases are only the columns that are associated with the elements in the upper levels, but when the processing has reached the uppermost level element, all the columns that correspond to the uppermost level element are obtained.

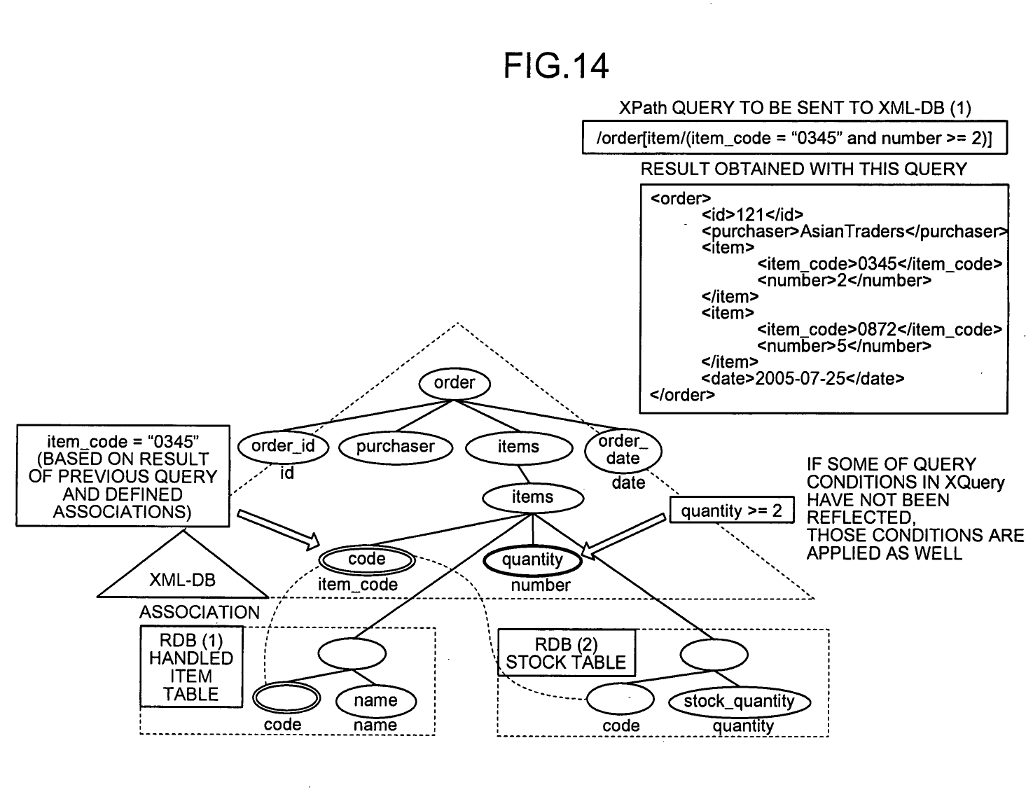

To be more specific, as shown in FIG. 14, based on the association of ‘code=0345’ obtained as a result of the previous query, it is determined that a query to the received-order DB 11 is made next. Then, a query is generated for querying about the data that matches the condition ‘code=0345’ and also the condition ‘quantity>=2’, which is among the conditions specified by the user in the XQuery query and has not yet been reflected. When the query is written in XPath, it reads “/order[item/(item_code=‘0345’ and number>=2)]”.

The generated query is sent to the received-order DB 11 (XML-DB) so that a query result that reads “<order><id>121</id><purchaser>AsianTraders</purchaser><item><item_code>0345</item_code><number>2</number></item><item><item_code>0872<item_code><number>5</number></item><date>2005-07-25</date></order>” is obtained from the order form XML, as the data that matches the conditions. In the example shown in the drawing, because the processing has reached the uppermost level element, all the columns that correspond to the uppermost level element are obtained.

Subsequently, when the element in the uppermost level in the XML is obtained (step S1309: Yes), the database integration reference apparatus 20 performs the processing of generating a query for sequentially obtaining all the elements in the lower levels below the uppermost level, sending the SQL query to the corresponding database, and obtaining a query result (steps S1310 through S1311) until all the elements below the uppermost level in the XML tree structure are obtained so as to sequentially obtain the values of the pieces of data that correspond to the lower-level elements (step S1312). The method of selecting the query type at steps S1310 is the same as the ones used at steps S1305 and S1307. When this processing is performed, the association with the query result of an upper element is specified as a condition with which the data is narrowed down. All the columns that correspond to the elements are obtained as-the values obtained from the databases.

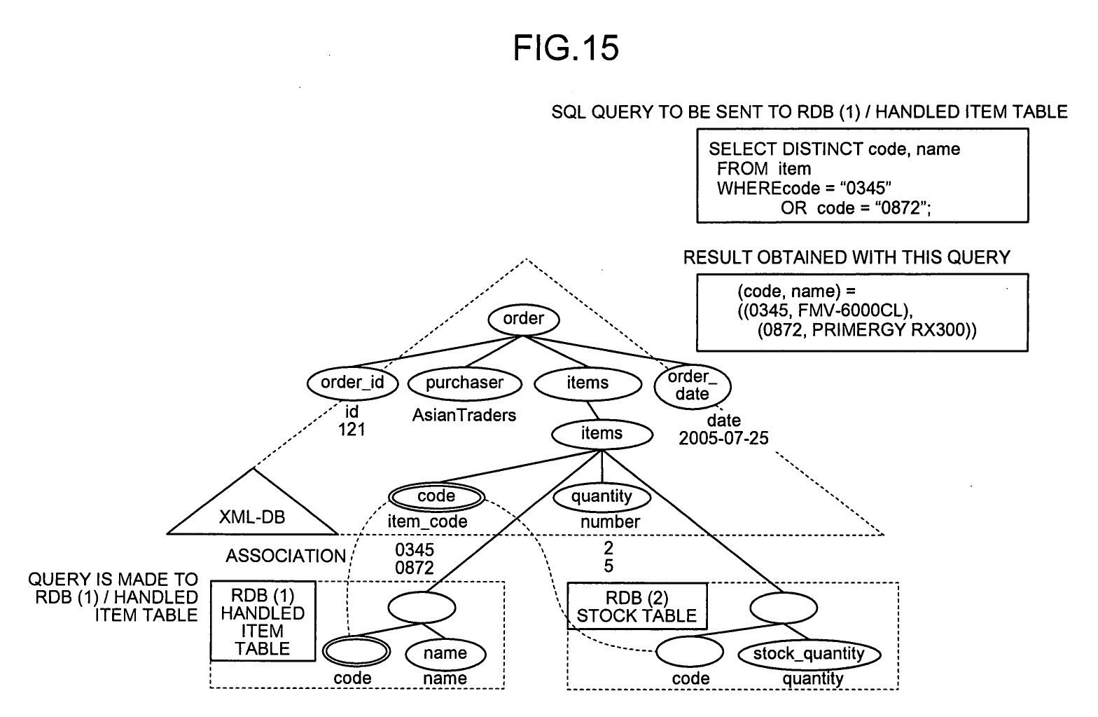

To be more specific, as shown in FIG. 15, an SQL query for querying about the data that matches the condition “code=‘0345’ OR code=‘0872’” to the item table in the received-order DB is generated, and the generated SQL query is sent to the item table. Thus, a query result that reads “(code, name)=(0345, FMV-6000CL), (0872, PRIMERGY RX300)” is obtained.

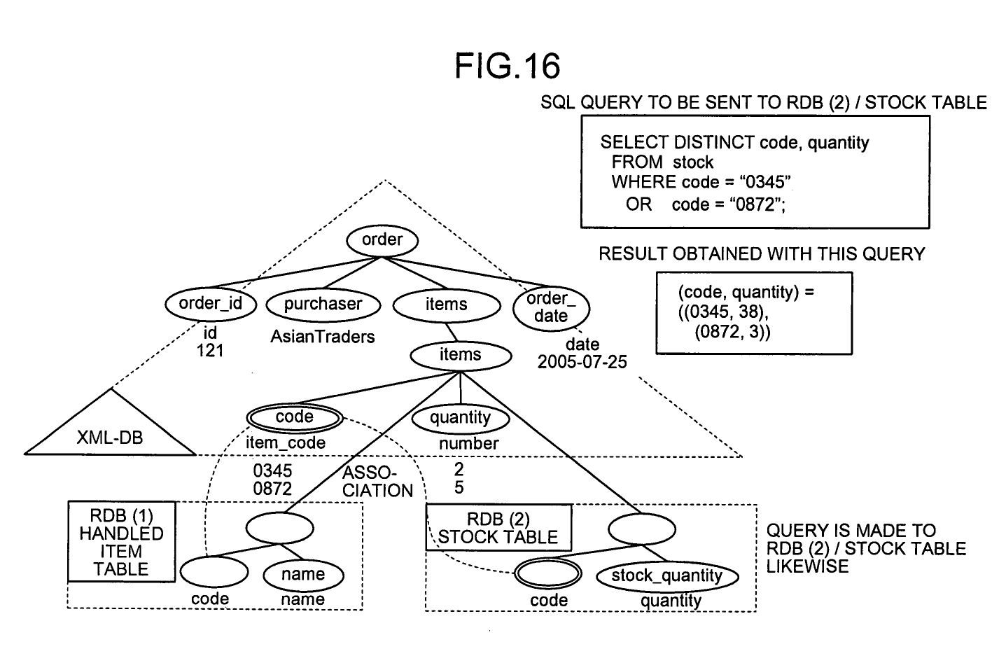

Further as shown in FIG. 16, an SQL query is generated for querying about the data that matches the condition “code=‘0345’ OR code=‘0872’” to the stock table in the stock DB 13, based on the query result mentioned above. The generated SQL query is sent to the stock table, so that a query result that reads “(code, quantity)=(0345, 38), (0872, 3)” is obtained.

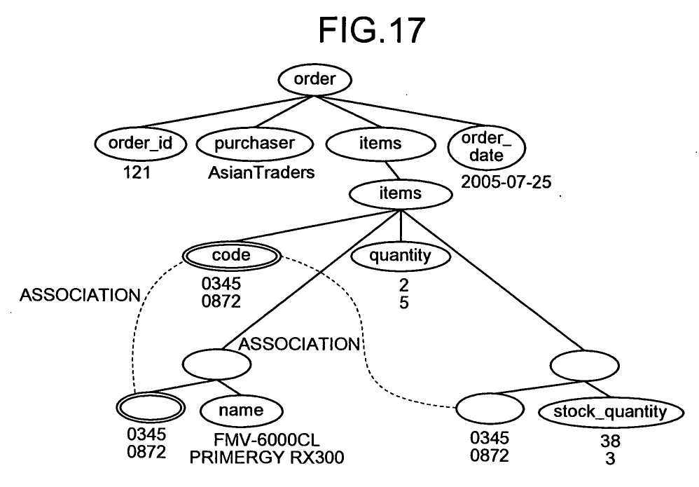

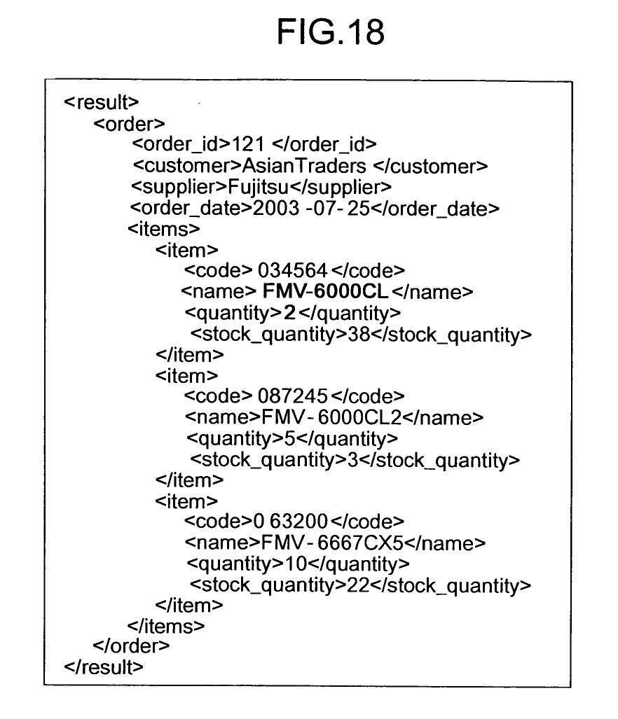

Then, when the data values of all the elements are obtained through the processing described above (step S1312: Yes), the database integration reference apparatus 20 constructs a query result XML from the obtained data values, while going through the XML tree structure from the top, as shown in FIG. 17 (step S1313). At this point in time, because there is a possibility that some of the query conditions that are specified by the user in the XQuery query have not yet been reflected, the database integration reference apparatus 20 checks for solutions that do not satisfy the query conditions and constructs the XML while eliminating such solutions from the XML of the final result (step S1314). Subsequently, the database integration reference apparatus 20 generates and outputs the query result XML, as shown in FIG. 18 (step S1315).

As a result of the series of processing described above, the data in the XML format is returned, as a query result, to the user terminal 10 that has originated the XQuery query. At steps S1307 through S1312, the processing goes up to the uppermost level element first, and then a query is made to the lower-level element again. Because two queries are made to the same database, it might seem wasteful. It is, however, necessary to perform this procedure because there is a possibility that a part of the XML document data may be missing otherwise. To be more specific, for example, in FIG. 13, only the “code” for the “FMV-6000CL” is obtained, but the final result needs to have, as shown in FIG. 17, the “code” and the “name” of each of the two items that are ordered in the order form of which the “order_id” is “121”. It is not possible to obtain these pieces of data until the element in the uppermost level is found, and the “order id” is confirmed.

The XML data that is returned as the result of the sub-query to the XML-DB is analyzed, using the XML parser included in the query processing engine unit 22b. The reason why the analysis is made is because, unless the value of the node used in the process of making associations is extracted, it is not possible to make a query to the next database. The analysis is made also for the purpose of preventing illegitimate data from mixing in, by checking if the result matches the schema of the XML defined in the metadata for integrating the databases. The XML data of which the analysis is finished is stored in the memory in an intermediary data format (a format that is compliant with a document object model (DOM)).

There are two possible methods to perform the processing when, in the virtual XML schema information in the metadata for integrating databases, the Simple Elements that appear directly below a single Complex Element appear in a different order in the returned XML data. One of the possible methods is to consider the XML data to be illegitimate XML data having a schema violation and treat it as an error (i.e. the data is discarded or an error message is returned and the processing is ended. The other possible method is to rearrange the order according to the virtual XML schema information. According to the first embodiment, the latter method is used. With this arrangement, according to the first embodiment, it is possible to change, with flexibility, the order in which tags appear in a virtual data view.

The XML data that is a result of the XQuery query is generated by outputting the results of the sub-queries to the databases that are stored in the memory in the intermediary data format, as XML data according to the virtual XML schema in the metadata for integrating databases.

Next, the method for optimizing the query order (the processing related to step S1304 in FIG. 10), which is mentioned in the procedure in the query processing, will be explained in detail. One potential problem in the query-type database integration process is that, because the data in the databases is obtained via a network, the speed at which the data is accessed is lower and also the load on the network is larger, compared to the case where the data is stored locally.

When the database integration reference apparatus 20 according to the first embodiment is used, when pieces of relevant data are sequentially obtained from a plurality of databases, the piece of data obtained first is obtained by narrowing down the data based on the conditions specified in the query from the user, whereas the other pieces of data that are obtained thereafter are obtained by narrowing down the data based on both the association with the previously obtained data and the conditions specified by the user. For this reason, when the data is not narrowed down sufficiently, a large amount of data is returned as a result of the queries to the databases. In this situation, not only it requires a long period of time to transfer the data, but also the load on the network is increased.

To explain this situation more specifically, as shown in FIG. 11, two conditions for narrowing down the data are written in the query from the user. The first condition is that “the item name is FMV-6000CL”, and the second condition is that “the number of items ordered is two or more”. The information about the item names is stored in the handled item table in the item DB 12. The information about the number of items ordered is stored in the received-order form XML in the received-order DB 11. For this reason, the database integration reference apparatus 20 needs to determine to which one of the databases, an SQL query should be issued first.

In this situation, when the amount of data obtained as a result of the first query is large, the amount of data obtained as a result of the next query, which uses the data resulting from the first query, also becomes large. Thus, even if the final query result to be returned to the user is the same, the amount of data collected in the database integration reference apparatus 20 during the process increases. In such a case, not only it takes a longer period of time to send the response to the user because the transfer of the data requires more time, but also the load on the network is increased. To cope with this problem, the database integration reference apparatus 20 determines the database to which the first query is made, after studying to which one of the databases, the SQL query should be issued first so as to make the amount of data in the query result smaller. This processing is performed by considering the four points, namely, (1) through (4) shown below, after obtaining the metadata of each of the databases themselves (which is different from the metadata for integration) from the databases.

(1) Restrictive Conditions Related to Redundancy of Data

By referring to the metadata of the databases, it is checked whether the column conditioned in the XQuery query is the main key of the table or whether a unique restriction is imposed on the column. If one of these conditions is satisfied, the column has no duplication of data. Thus, there is a high possibility of being able to narrow down the data.

(2) The Number of Pieces of Data

By referring to the metadata of the databases, it is checked if the number of records in the table is large. It is checked because when the number of records in the table is large, there is a higher possibility that a large number of records are returned as the query result.

(3) The Type of Data and the Number of Digits

By referring to the metadata of the databases, it is checked if the data type of the column is one with a small variety, for example, numerals or true/false values, or if the number of digits is small. In such situations, there is a higher possibility that the column has a large amount of duplication of data. Thus, there is a higher possibility that a large number of records are returned as the query result.

(4) The Type of Condition Specification in the Condition Expressions Specified by the User

It is checked whether the condition expression in the XQuery query is specified using an equality sign or an inequality sign. It is checked because when the condition is specified using an equality sign, there is a higher possibility of being able to narrow down the data than when the condition is specified using an inequality sign.

The database integration reference apparatus 20 checks whether each of these four criteria is satisfied and gives a score to each of the query conditions according to the result of the checking. The database integration reference apparatus 20 starts the query with the database that involves the condition with the highest score. In the example shown in FIG. 12, it has been judged that there is a higher possibility of being able to narrow down the data if the query with the condition “name=‘FMV-6000CL’” is issued to the handled item table first.

After the database with which the query is started is determined using the optimization method, the elements are sequentially obtained through the processing that moves to an element respectively positioned immediately above, toward the uppermost level element in the XML at first, using the association information, as explained in the description of the procedure in the query processing.

As explained so far, according to the first embodiment, not only a means of access to the databases that can be used in common among the databases is provided, but also an XML data view in a further upper level is made available. In other words, the entire relevant data that exists in the plurality of databases is presented to the user as a virtual XML document. As a result of a query to extract a part of the XML document, data reference is performed in such a manner that an XML document is returned. Also, when the user issues a query, it is judged in what order, from which database, and with what query, the data should be obtained, based on the metadata for integration that is prepared in advance. According to the result of the judgment, the necessary data is obtained, and the obtained data is constructed into an XML document and returned to the user. Thus, the user does not have to be concerned about the structure in which the data is stored and does not have to recognize at all in which one of the databases, each piece of data is stored. Accordingly, it is possible to treat the plurality of databases as if they were one database.

Also, according to the first embodiment, even if pieces of data of the same type are stored in a plurality of databases and the user does not know in which one of the databases one of the pieces of data having a certain value is stored, when the user issues an XML document query, the database integration reference apparatus 20 sends a query to each of all the databases that have a possibility of storing the piece of data therein, based on the metadata for integration and finds the data automatically. With this arrangement, the user does not have to look for the data from the databases. Thus, it is possible to treat the plurality of databases as if they were one database.

Further, according to the fist embodiment, when data is obtained from the databases, a plan for issuing the queries is made so that the query results become as small as possible, based on the meta information of the databases and the contents of the queries, and the data is sequentially obtained from the databases according to the plan. With this arrangement, the data is narrowed down to the result data by manipulating the order in which the queries are made. Thus, it is possible to reduce the amount of data being transferred and to shorten the period of time required for the queries, and also to reduce the load on the network.

In addition, according to the first embodiment, after the database with which the query is started is determined, the data values corresponding to the elements are sequentially obtained, starting with the element of which the data value is obtained first, and in such a manner that the processing moves onto an upper-level element each time in the XML document tree structure. When the data value of the uppermost level element is obtained, the data values of all the lower level elements are sequentially obtained, while going down the structure from the uppermost level. This procedure is always the same regardless of the definition of the XML document structure and the contents of the queries. With this arrangement, it is possible to obtain, without any exception, the entire XML document that serves as the query result, regardless of the definition of the XML document structure and the contents of the queries. Also, it is possible to make the number of times queries are made to the databases small.

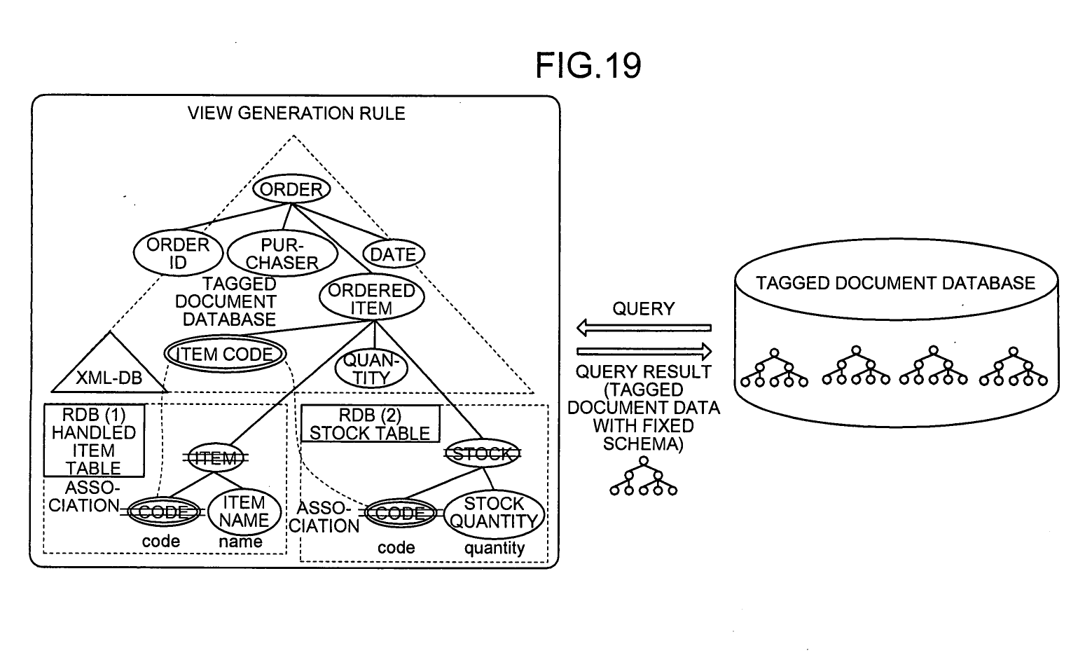

The first embodiment described above has the characteristics as described below. FIG. 19 is a drawing for explaining the characteristics of the first embodiment. As shown in the drawing, the first embodiment has a function to make it possible to treat an RDB in the same way as an XML-DB is treated.

It is assumed that an XML-DB stores therein a large number of pieces of XML document data with a predetermined fixed schema and has an interface so that, when having received a query, the XML-DB returns one or more pieces of XML document data that correspond to the conditions while the data remains in the current format. As many pieces of XML document data as satisfy the conditions are returned. When it is assumed that the XML-DB has such an interface, it is possible to consider that the schema in the pieces of XML document data returned from the XML-DB is fixed. Thus, it is possible to embed the fixed schema as a part of the schema of the data view in an XML format that is visibly presented to the user.

To embed the schema of the pieces of XML document data that are returned from the XML-DB into the schema of the data view in the XML format, a view generation rule defines the schemas as to how to connect the XML tree structure returned from the XML-DB to the XML tree structure generated from the data structure of another RDB and thereby a view with what tree structure is obtained and also defines the entries that are used to make associations between these tree structures.

In the query processing, the XML document data returned from the XML-DB is embedded, without being modified, as a part of the XML document data that serves as the query result. In other words, the XML document data is treated in the same way as XML sub-trees structured from a plurality of RDBs are treated. It is safe to say that the tree structure that defines the schema of the XML document data view also defines the schema of the XML document data returned from the XML-DB, according to the first embodiment.

This method, however, can be applied only to an XML-DB that has the hypothetical interface described above. Also, it is not possible to apply this method when the XML document data returned from the XML-DB has a semi-structured characteristic. Further, the schema of the integrated data view that is presented to the user is also restricted by the schema of the XML document data returned from the XML-DB.

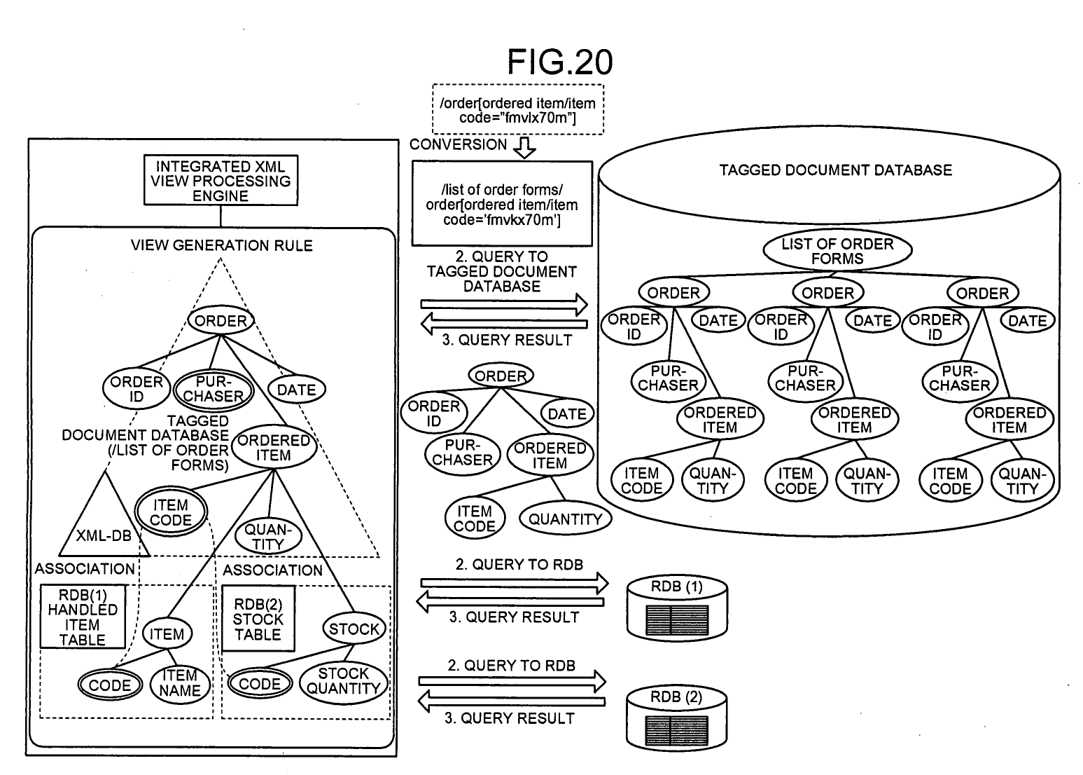

To solve the problem that remains even after the invention according to the first embodiment is applied, and also to present other functions that may be added to the first embodiment, more exemplary embodiments are presented below as a second embodiment of the invention. Firstly, a first characteristic of the second embodiment will be explained. FIG. 20 is a drawing for explaining the first characteristic of the second embodiment.

According to the first embodiment, it is assumed that the XML-DB stores therein a large number of pieces of XML document data with a predetermined fixed schema and has an interface so that, when having received a query, the XML-DB returns one or more pieces of XML document data that correspond to the conditions, while the data remains in the current format. Thus, this arrangement is not applicable to an XML-DB that only has an interface of other kinds. Generally speaking, however, the interfaces in many XML-DBs are arranged in such a manner that one (or more than one) large piece of XML document data is stored, and an instruction is issued so that a part of the XML document data is extracted in the query language, and a partial data of the stored XML document data is returned. Additionally, when a path to the repetitive structure in the XML data is specified in the database information in the metadata for integrating the databases, it is necessary to correct the XPath so that the specified path is added at the beginning before the issuance.

To cope with this situation, as shown in FIG. 20, in the database integration reference system according to the second embodiment, to be able to apply the invention even to the case where the XML-DB has such an interface, even if there is a certain repetitive structure in the XML document data tree structure stored in the XML-DB, the path from the root node to the repetitive structure in the tree structure is recorded in the view generation rule. The database integration reference system according to the second embodiment has a function to make it possible to treat the XML-DB as if the XML-DB had the hypothetical interface according to the database integration reference system of the present invention, by automatically modifying, before the issuance, the sub-query issued by this system according to the recorded path. With this arrangement the database integration reference system according to the second embodiment is compatible with many types of XML-DBs.

The processing of automatically modifying, before the issuance, the sub-query issued by this system, according to the path that is from the root node to the repetitive structure and is recorded in the view generation rule is executed by the query processing engine unit 22b. The path from the root node to the repetitive structure is stored in the metadata for integration 21a.

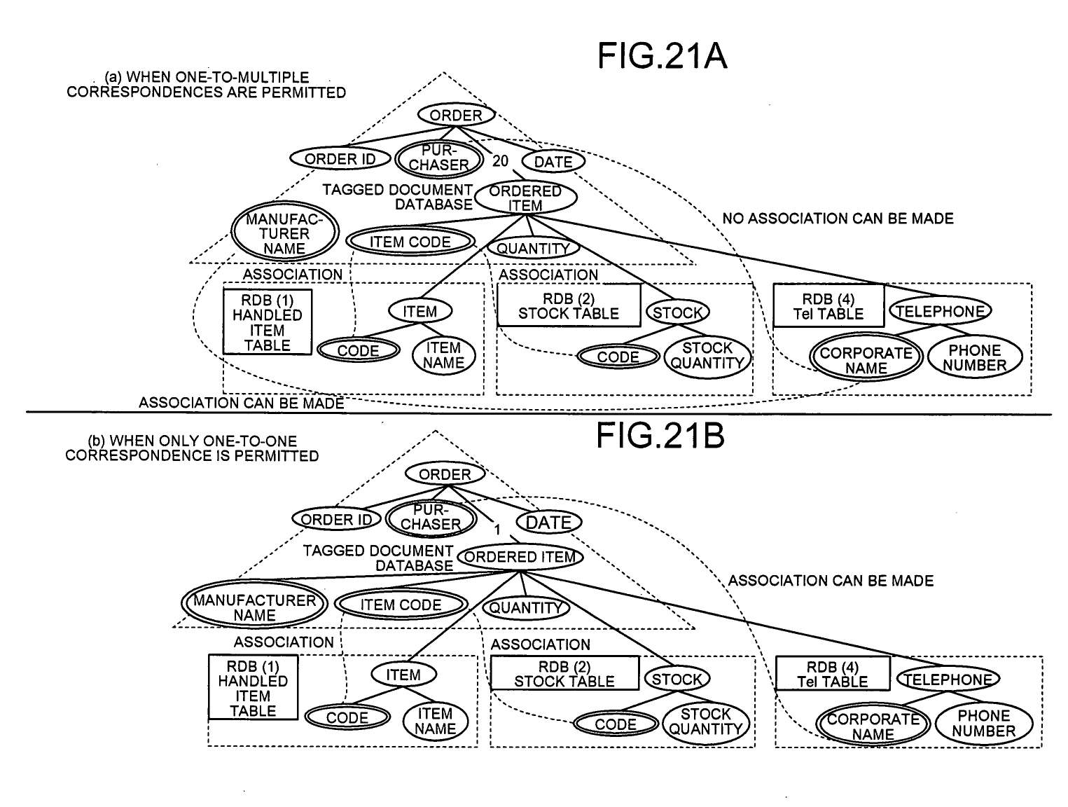

Next, a second characteristic of the second embodiment will be explained. FIGS. 21A and 21B are drawings for explaining a second characteristic of the second embodiment. In the database integration reference system according to the first embodiment, the view generation rule defines the connection between the XML document data tree structure from the XML-DB and the tree structure in which RDB are combined. There are two types of definition: One is the definition of the schema as to how to connect the tree structures to each other, and a data view with what tree structure is obtained. The other is the definition of associations as to which nodes are used in making the associations between the tree structures.

These definitions are related to each other, and it is not possible to set the definitions without some kind of order. The nodes that are used to make an association need to be in a one-to-one correspondence. Thus, an XML-DB has a restriction as follows: a node used in the definition of association needs to be a terminal node, which is a child node of an intermediate node being the connection point in the definition of the schema. Because of this restriction, a problem arises where the level of flexibility in defining the schema of the view is low, and it is not possible to define a view with flexibility (see FIG. 21A).

To cope with this situation, as shown in FIG. 21B, in the database integration reference system according to the second embodiment, it is possible to specify, in the view schema definition in the view generation rule, the maximum number of appearances for each of the intermediate nodes in the sub-tree that corresponds to the XML-DB. When the user generates a view generation rule, by setting the definition appropriately, it is possible for the user to calculate the number of appearances of each of the intermediate nodes or the ratio of number of appearances between the intermediate nodes. With this arrangement, there is no need to limit the node used in the definition of associations to a child node of the intermediate node being the connection point in the schema definition. It is possible to specify a node in an upper level or in a lower level as a node with which an association is made, in the range that a one-to-one correspondence is possible. Accordingly, the database integration reference system according to the second embodiment makes the level of flexibility for the data view definition higher.

The processing of calculating the number of appearances of each of the intermediate nodes or the ratio of number of appearances between the intermediate nodes, based on the maximum number of appearances of each of the intermediate nodes in the sub-tree corresponding to the specified XML-DB and judging if it is possible to specify a node in an upper level or in a lower level as a node with which an association is made, in the range that a one-to-one correspondence is possible, is executed by the query processing engine unit 22b. The maximum number of appearances of each of the intermediate nodes in the sub-tree corresponding to the specified XML-DB is stored in the metadata for integration 21a.

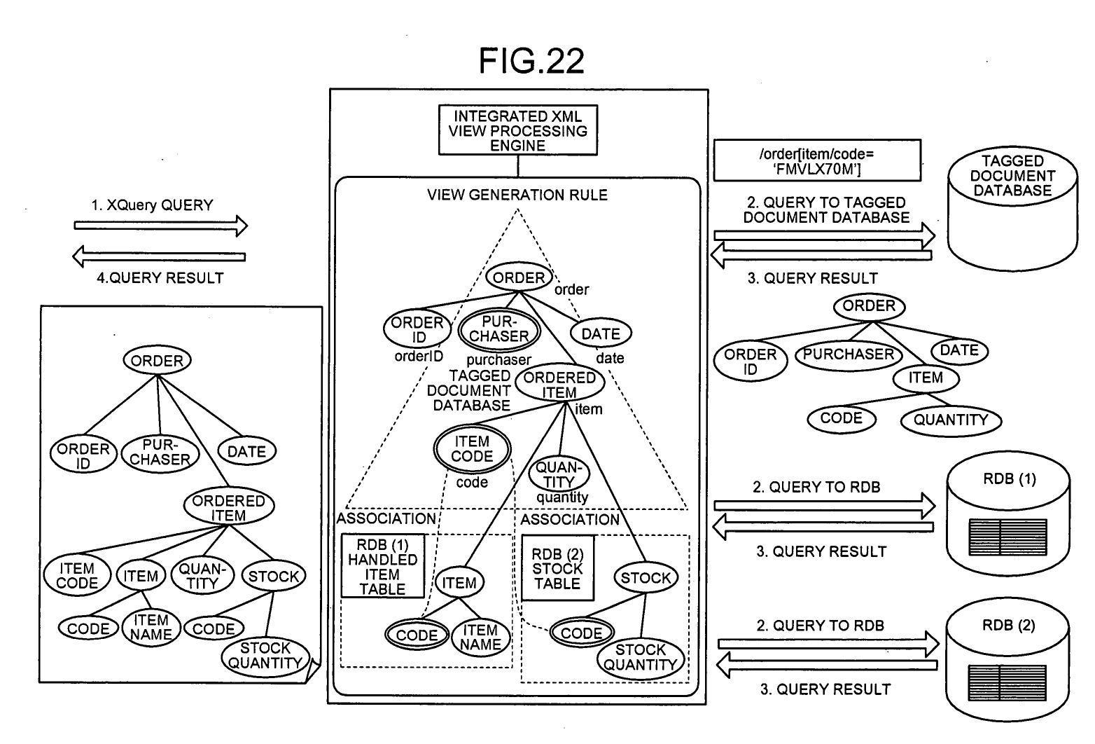

Next a third characteristic of the second embodiment will be explained. FIG. 22 is a drawing for explaining the third characteristic of the second embodiment. According to the first embodiment, the schema of the XML document data returned from the XML-DB is shown as the way it is, as a part of the tree structure of the integrated data view. With this arrangement, there may be some cases where the schema definition of the integrated data view is restricted, and the user is not able to define, with flexibility, a view schema that the user wishes to use. In particular, there is a possibility that, in a view, the user may wish to change the names of the tags from the ones used in the original XML document data. In addition, when a different name for a node in the XML-DB is defined in the database information in the metadata for integrating databases, the tag name in the path needs to be replaced with the different name when an XPath is generated.

To cope with this situation, as shown in FIG. 22, in the database integration reference system according to the second embodiment, in the view schema definition in the view generation rule, it is possible to specify a different name of each of the node for the use in the databases. When a sub-query is send to the XML-DB and when the returned XML document data is analyzed, the different name is used. When the analysis of the XML document data is finished, the name of each tag is replaced with the original name, which is used for the view display. Thus, it is possible to replace the tag names in the XML document data in the XML-DB. In other words, if a different name of a node for the use in the XML-DB is defined in the database information in the metadata for integrating databases, when the XML data returned from the XML-DB is parsed, the different name is used in the parsing. With this arrangement, when the database integration reference system according to the second embodiment is used, the level of flexibility in the view definition is enhanced.

The processing of changing, in the view schema definition in the view generation rule, the name of each of the nodes to a different name from the one used in the databases is executed by the query processing engine unit 22b. The name of each of the nodes and a corresponding name for the use in the databases as well as the relationship between the names are stored in the metadata for integration 21a.

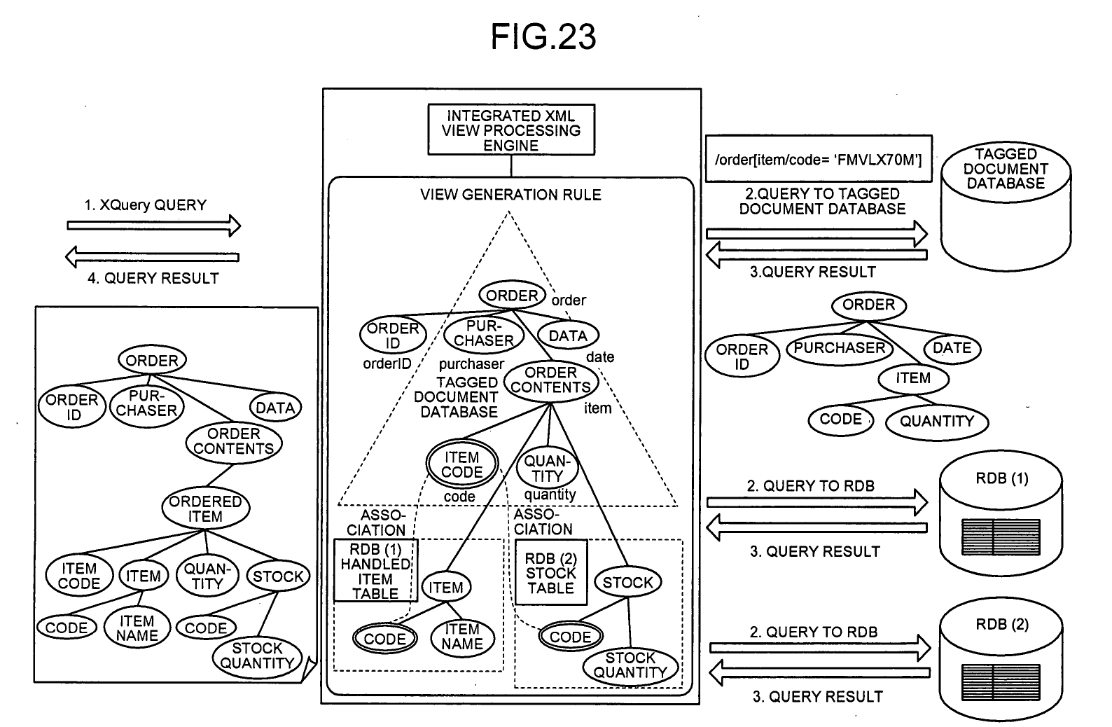

Next, a fourth characteristic of the second embodiment will be explained. FIG. 23 is a drawing for explaining the fourth characteristic of,the second embodiment. According to the first embodiment, the schema of the XML document data returned from the XML-DB is shown as the way it is, as a part of the tree structure of the integrated data view. With this arrangement, there may be some cases where the schema definition of the integrated data view is restricted, and the user is not able to define, with flexibility, a view schema that the user wishes to use. In particular, there is a possibility that the user may wish to insert, in a data view, a tag that does not exist in XML document data in the XML-DB. In addition, if a Tag Element exists in the XML sub-tree, the XPath needs to be generated while the Tab Element is ignored.

To cope with this situation, as shown in FIG. 23, in the database integration reference system according to the second embodiment, it is possible to specify an imaginary node in the view schema definition in the view generation rule. The imaginary node is not used when a sub-query is send to the XML-DB and when the returned XML document data is analyzed. When the analysis of the XML document data is finished, the imaginary node tag is inserted. Thus, it is possible to change the tree structure in the data view even for XML document data in the XML-DB. To be more specific, when a Tag Element exists in the XML sub-tree, in the virtual XML schema information in the metadata for integrating databases, the tag is inserted when the result of the XQuery query is constructed. With this arrangement, when the database integration reference system according to the second embodiment is used, the level of flexibility in the view definition is enhanced.

The processing of inserting the tag of the specified imaginary node when the analysis of the XML document data serving as the query result is finished is executed by the query processing engine unit 22b. The tag information of the specified imaginary node is stored in the metadata for integration 21a.

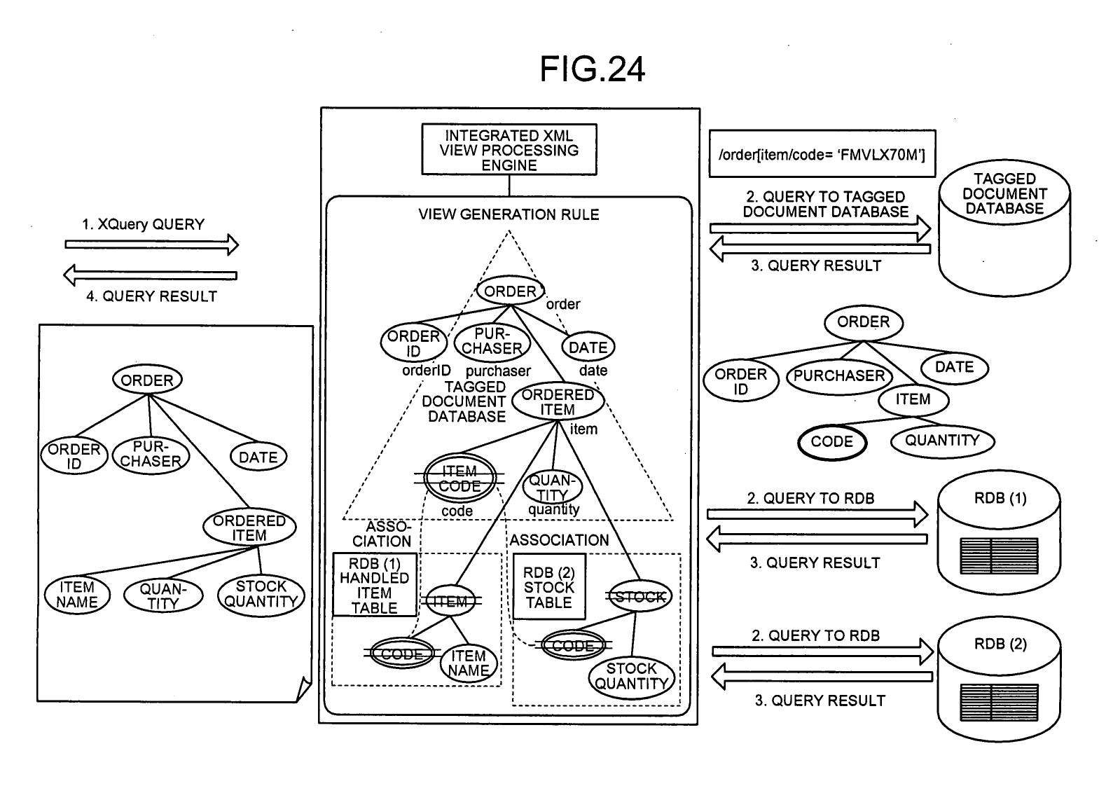

Next a fifth characteristic of the second embodiment will be explained. FIG. 24 is a drawing for explaining the fifth characteristic of the second embodiment. According to the first embodiment, the schema of the XML document data returned from the XML-DB is shown as the way it is, as a part of the tree structure of the integrated data view. With this arrangement, there may be some cases where the schema definition of the integrated data view is restricted, and the user is not able to define, with flexibility, a view schema that the user wishes to use. In particular, there is a possibility that, in a view, the user may wish to make the node existing in the original XML document data invisible.

To cope with this situation, as shown in FIG. 24, in the database integration reference system according to the second embodiment, it is possible to have a setting in the view schema definition in the view generation rule so that each of the nodes is not displayed. These nodes are used, as normal, when a sub-query is send to the XML-DB and when the returned XML document data is analyzed. When the analysis of the XML document data is finished, the tag of each of the nodes is removed. Thus, it is possible to change the tree structure in the view even for XML document data in the XML-DB. To be more specific, when the attribute indicating “Visible or Invisible” is set to “FALSE” in a Complex Element or a Simple Element, in the virtual XML schema information in the metadata for integrating databases, the tag of the node is deleted when the result of the XQuery query is constructed. With this arrangement, when the database integration reference system according to the present invention is used, the level of flexibility in the view definition is enhanced.

The processing of removing the tag of the node that is specified not to be displayed when the analysis of the XML document data serving as the query result is finished is executed by the query processing engine unit 22b. The tag information of the node that is specified not to be displayed is stored in the metadata for integration 21a.

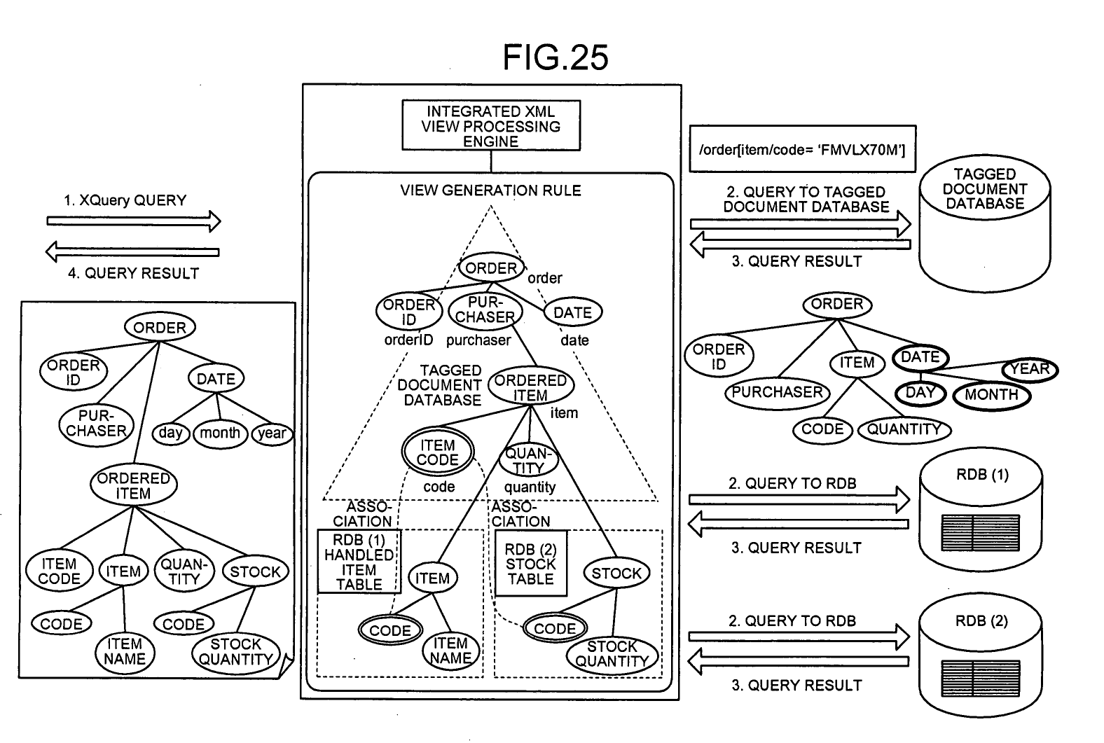

Next, a sixth characteristic of the second embodiment will be explained. FIG. 25 is a drawing for explaining the sixth characteristic of the second embodiment. According to the first embodiment, the schema of the XML document data returned from the XML-DB is shown as the way it is, as a part of the tree structure of the integrated data view. This arrangement is not applicable to a case where the XML document data returned from the XML-DB has a semi-structured characteristic.

To cope with this situation, as shown in FIG. 25, in the database integration reference system according to the present invention, it is possible to designate so that for a particular node that is specified in the view schema definition in the view generation rule, the schema of its subordinates will not be checked. When the XML document data returned from the XML-DB is analyzed, what appears below the specified node is all treated simply as a character string, and the schema of that portion will not be checked. In other words, when the “schemaless designation” option of a Simple Element is set to “TRUE” in the virtual XML schema information in the metadata for integrating databases, no parsing and no processing is performed on the contents of the tag, and it is treated as a mere character string. When the “schemaless designation” option of a Simple Element is set to “TRUE”, and the subordinates of the tag are not parsed, the character string is output, as the way it is, as the value of the tag to serve as the result of the XQuery query. With this arrangement, it is possible to apply the configuration to the data stored in the XML-DB even if a part of the schema of the data has a semi-structured characteristic. With this arrangement, the database integration reference system according to the present invention is applicable, with flexibility, to an XML-DB in which the stored data has a semi-structured characteristic.

The processing of displaying, as a mere character string, the information of the node for which it has been designated to cancel the schema checking when the analysis of the XML document data serving as the query result is finished, is executed by the query processing engine unit 22b. The tag information of the node for which it has been designated to cancel the schema checking is stored in the metadata for integration 21a.

According to the first embodiment and the second embodiment that have been explained, when the pieces of data that are arranged so as to be distributed in a plurality of databases including an XML-DB and an RDB are referenced, it is possible to reference the data without being concerned about the physical distribution of the databases and by simply following the basic method of use of the XQuery. In addition, because the flexibility level of the schema definition in the integrated data view is high, it is possible to make flexible queries using XQuery, with the feeling as if an access was made to one database.

So far, the first and the second embodiments of the present invention have been explained. The present invention may be, however, embodied in various forms other than the first and the second embodiments, as long as it is within the scope of the technical ideas defined in the claims. In the following sections, various other exemplary embodiments will be explained by dividing them into the categories of: (1) tagged document; (2) databases; (3) metadata for integration; (4) access processing; (5) system configuration etc.; and (6) program.

(1) Tagged Document

For example, in the first and the second embodiment, the example in which an XML is used as a tagged document is explained. However, the present invention is not limited to this example. It is acceptable to use other tagged documents such as a Hyper Text Markup Language (HTML) or a Standard Generalized Markup Language (SGML).

In the description of the first and the second embodiments, an example is used in which “XQuery”, which is a query language for which the World Wide Web Consortium (W3C) is working on its standardization process, is used in the query sent to the XML data view, whereas “XPath (or an XPath-compatible query language)” is used in the query sent to the XML-DB. However, the present invention is not limited to this example. It is acceptable to use other query languages, including “XQuery” and “XPath (or an XPath-compatible query language)”, in each of both types of queries.

(2) Databases

In the description of the first and second embodiments, the example in which the XML-DB and the RDBs are integrated is explained. However, the present invention is not limited to this example. It is possible to apply the present invention in the same way to a case where other types of databases are integrated. For example, the database may be an object-oriented database or an object relational database. In an object-oriented database, the data is identified by a path in a hierarchical structure. Thus, by using a processing and a function that convert the hierarchical structure into a hierarchical structure of a tagged document, it is possible to treat the object-oriented database as if it was an XML-DB. On the other hand, the data management method of an object relational database is compliant with that of an RDB. Thus, it is possible to treat an object relational database substantially in the same way as an RDB is treated.

(3) Metadata for Integration

In the description of the first and the second embodiments, the example in which one piece of metadata for integration is provided is explained. However, the preset invention is not limited to this example. It is acceptable to provide a plurality of pieces of metadata for integration, depending on the method of integrating the databases. For example, it is one idea to provide a plurality of pieces of metadata for integration that correspond to different modes in which the query result is output.

(4) Access Processing

In the first embodiment, the example is based on an assumption that Globus Toolkit 4+OGSA-DAI WSRF 2.1 is used for the RDBs, whereas an application programming interface (API) that is compatible with XPath is used for the XML-DB, to access the plurality of different types of databases. However, the present invention is not limited to this example. How to make a query to the different types of databases is irrelevant. It is acceptable to access to the databases with any method. In particular, the XPath-compatible API is a sub-set of the XPath, which is an XML search language. Thus, it is possible to modify so that the query processing is performed using the XPath.

(5) System Configuration etc.

The constituent elements of the apparatuses shown in the drawings (especially, the database integration reference apparatus 20) are based on functional concepts. The constituent elements do not necessarily have to be physically arranged in the way shown in the drawings. In other words, the specific mode in which the apparatuses are distributed and integrated is not limited to the one shown in the drawing. A part or all of the apparatuses may be distributed or integrated functionally or physically in any arbitrary units, according to various loads and the status of use. A part or all of the processing functions offered by the apparatuses may be realized by a CPU and a program analyzed and executed by the CPU, or may be realized as hardware with wired logic.

Of the various types of processing explained in the description of the first and the second embodiments, it is acceptable to manually perform a part or all of the processing that is explained to be performed automatically. Conversely, it is acceptable to automatically perform, using a publicly-known technique, a part or all of the processing that is explained to be performed manually. In addition, the processing procedures, the controlling procedures, the specific names, and the information including various types of data and parameters that are presented in the text and the drawings may be modified in any form, except when it is noted otherwise.

(6) Computer Program

The various types of processing explained in the description of the first and second embodiments may be realized through execution of a program, which is prepared in advance, in a computer system such as a personal computer, a server, or a work station.

As another exemplary embodiment, the functions in the first and the second embodiments may be realized by reading and executing a program recorded on a predetermined recording medium in a computer system. The predetermined recording medium may be a “portable physical medium” such as a Flexible Disk (FD), a Compact Disc Read Only Memory (CD-ROM), a Magneto Optical (MO) disk, a Digital Versatile Disk (DVD), a Magneto Optical Disk, or an Integrated Circuit (IC) card, or a “stationary physical medium” such as a hard disk drive (HDD) provided on the inside or the outside of a computer system, a Random Access Memory (RAM), or a Read-Only Memory (ROM), or a “communication medium” that stores there in a program for a short period of time when the program is transmitted, such as a public circuit that is connected via a modem, or a Local Area Network (LAN)/a Wide Area Network (WAN) to which another computer system and a server are connected. The predetermined recording medium may be any recording medium that records thereon a program that is readable by a computer system.

To be more specific, the program used in this exemplary embodiment is recorded on a recording medium such as a “portable physical medium”, a “stationary physical medium”, or a “communication medium” in such a manner that the program is computer-readable. The computer system realizes the same functions as described in the exemplary embodiments above, by reading the program from the recording medium and executing the read program. The program used in this exemplary embodiment is not limited to being executed by a computer system. The present invention is applicable to an example in which other computer system or a server executes the program or in which other computer system and a server collaborate to execute the program.

According to the present invention, it is possible to reference the pieces of data that are distributed in the plurality of different types of databases including the database that returns the query result as the data that is uniquely identified in the hierarchical structure, by outputting, in the integrated view, the query result obtained as a result of the queries that are made, in the query formats, to the databases. Thus, an effect is achieved where it is possible to make the queries without being concerned about the pieces of data being distributed. Accordingly, the level of flexibility in the database development work is enhanced.

According to the present invention, it is possible to reference the pieces of data that are distributed in the plurality of different types of databases including the tagged document database that returns the query result as the tagged document of which the structure is predetermined, by outputting, in the integrated view, the query result obtained as a result of the queries that are made, in the query formats, to the databases. Thus, an effect is achieved where it is possible to make the queries without being concerned about the data being distributed. Accordingly, the level of flexibility in the database development work is enhanced.

Further, according to the present invention, it is possible to store the specific repetitive structure included in a tagged document data within the tagged document database and to obtain the data as the query result, based on the stored repetitive structure. Thus, an effect is achieved where the range of tagged document databases that can be the targets of the integration is widened.

In addition, according to the present invention, the schema of the tagged document data returned from the tagged document database does not restrict the nodes that can be used for making associations with another database. Thus, there are more options of nodes that can be used for making associations. Accordingly, an effect is achieved where the level of flexibility in the design of the integrated data view is improved and also the level of flexibility in the upper-level application development is improved.

Further, according to the present invention, it is possible to determine the names of the elements defined in the schema of the integrated data view without dependency on the names of the elements defined in the schema of the tagged document data returned from the tagged document database. Thus, an effect is achieved where it is possible to determine the names of the elements defined in the schema of the integrated data view in such formats that are easy to understand for the users.

In addition, according to the present invention, it is possible to put the one or more elements that do not exist in the schema of the tagged document data returned from the tagged document database into the schema of the integrated data view. Thus, it is possible to determine, with flexibility, the schema of the integrated data view. Accordingly, an effect is achieved where the level of flexibility in the upper-level application development is significantly improved.

Furthermore, according to the present invention, it is possible to arrange so that the schema of the integrated data view does not include one or more of the elements that exist in the schema of the tagged document data returned from the tagged document database. Thus, it is possible to determine, with flexibility, the schema of the integrated data view. Accordingly, an effect is achieved where the level of flexibility in the upper-level application development is significantly improved.

Moreover, according to the present invention, even if the tagged document data returned from the tagged document database is indefinite or has a semi-structured characteristic, it is possible to integrate the tagged document database. Thus, an effect is achieved where the range of tagged document databases that can be the targets of the integration is widened.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A computer-readable recording medium that stores therein a computer program that causes a computer to reference pieces of data that are distributed in a plurality of different types of databases including a database that returns a query result as data that is uniquely identified in a hierarchical structure, by outputting, in an integrated view, a query result obtained as a result of queries that are made, in query formats, to the databases, the computer program causing the computer to execute:
storing a view generation rule for generating the integrated view that is defined by a correspondence relationship between elements in the data that is uniquely identified in the hierarchical structure and elements in the databases and a correspondence relationship among the elements in the databases; and
structuring, based on the view generation rule, the query result obtained as the result of the queries that are made, in the query formats, to the databases, in response to a query that is made, in a query format, to the integrated view.

2. The computer-readable recording medium according to claim 1, wherein
the storing includes storing a repetitive structure that is included in the tagged document and in which a same structure is repeated, and
the structuring includes, when a query is made to the database that returns the query result as the tagged document, data that is included in the repetitive structure is obtained, using the repetitive structure stored at the storing.

3. The computer-readable recording medium according to claim 1, wherein
the storing includes storing a maximum number of appearances of elements in the view generation rule, and
the structuring includes
judging a number of appearances of elements in the tagged document; and
judging whether elements can be brought into correspondence between the databases, based on the maximum number of appearances of the elements in the view generation rule and the number of appearances.

4. The computer-readable recording medium according to claim 1, wherein
the storing includes storing names of the elements in the tagged document and names of the elements in the databases, the elements in the tagged document being kept in correspondence with the elements in the databases by the view generation rule, and
the structuring includes receiving the query that is made to the integrated view and in which the names of the elements in the tagged document are used, and converting the names of the elements in the tagged document into the names of the elements in the databases, so that the query result is obtained as the result of the queries that are made to the databases and in which the names of the elements in the databases are used.

5. The computer-readable recording medium according to claim 1, wherein
the storing includes storing one or more element that do not exist in the tagged document, and
the structuring includes structuring the query result obtained as the result of the queries that are made, in the query formats, to the databases, in response to the query that is made, in the query format, to the integrated view so as to include the one or more elements that do not exist in the tagged document.

6. The computer-readable recording medium according to claim 1, wherein
the storing includes storing an instruction indicating that one or more of the elements in the tagged document should be hidden in the view generation rule, and
the structuring includes structuring, when the query result obtained as the result of the queries that are made, in the query formats, to the databases, in response to the query that is made, in the query format, to the integrated view, based on the view generation rule, the one or more of the elements in the tagged document are hidden based on the instruction.

7. The computer-readable recording medium according to claim 1, wherein
the structuring includes structuring, when the query result obtained as the result of the queries that are made, in the query formats, to the databases, in response to the query that is made, in the query format, to the integrated view, based on the view generation rule, if there are one or more elements that are not included in the view generation rule, each of the elements that are not included is treated as a character string.

8. A computer-readable recording medium that stores therein a computer program that causes a computer to reference pieces of data that are distributed in a plurality of different types of databases including a tagged document database that returns a query result as a tagged document of which a structure is predetermined, by outputting, in an integrated view, a query result obtained as a result of queries that are made, in query formats, to the databases, the computer program causing the computer to execute:
storing a view generation rule for generating the integrated view that is defined by a correspondence relationship between elements in the tagged document and elements in the databases and a correspondence relationship among the elements in the databases; and
structuring, based on the view generation rule, the query result obtained as the result of the queries that are made, in the query formats, to the databases, in response to a query that is made, in a query format, to the integrated view.

9. The computer-readable recording medium according to claim 8, wherein
the storing includes storing a repetitive structure that is included in the tagged document and in which a same structure is repeated, and
the structuring includes, when a query is made to the database that returns the query result as the tagged document, data that is included in the repetitive structure is obtained, using the repetitive structure stored at the storing.

10. The computer-readable recording medium according to claim 8, wherein
the storing includes storing a maximum number of appearances of elements in the view generation rule, and
the structuring includes
judging a number of appearances of elements in the tagged document; and
judging whether elements can be brought into correspondence between the databases, based on the maximum number of appearances of the elements in the view generation rule and the number of appearances.

11. The computer-readable recording medium according to claim 8, wherein
the storing includes storing names of the elements in the tagged document and names of the elements in the databases, the elements in the tagged document being kept in correspondence with the elements in the databases by the view generation rule, and
the structuring includes receiving the query that is made to the integrated view and in which the names of the elements in the tagged document are used, and converting the names of the elements in the tagged document into the names of the elements in the databases, so that the query result is obtained as the result of the queries that are made to the databases and in which the names of the elements in the databases are used.

12. The computer-readable recording medium according to claim 8, wherein
the storing includes storing one or more element that do not exist in the tagged document, and
the structuring includes structuring the query result obtained as the result of the queries that are made, in the query formats, to the databases, in response to the query that is made, in the query format, to the integrated view so as to include the one or more elements that do not exist in the tagged document.

13. The computer-readable recording medium according to claim 8, wherein
the storing includes storing an instruction indicating that one or more of the elements in the tagged document should be hidden in the view generation rule, and
the structuring includes structuring, when the query result obtained as the result of the queries that are made, in the query formats, to the databases, in response to the query that is made, in the query format, to the integrated view, based on the view generation rule, the one or more of the elements in the tagged document are hidden based on the instruction.

14. The computer-readable recording medium according to claim 8, wherein
the structuring includes structuring, when the query result obtained as the result of the queries that are made, in the query formats, to the databases, in response to the query that is made, in the query format, to the integrated view, based on the view generation rule, if there are one or more elements that are not included in the view generation rule, each of the elements that are not included is treated as a character string.

15. A database integration reference method of referencing pieces of data that are distributed in a plurality of different types of databases including a database that returns a query result as data that is uniquely identified in a hierarchical structure, by outputting, in an integrated view, a query result obtained as a result of queries that are made, in query formats, to the databases, the method comprising:
storing a view generation rule for generating the integrated view that is defined by a correspondence relationship between elements in the data that is uniquely identified in the hierarchical structure and elements in the databases and a correspondence relationship among the elements in the databases; and
structuring, based on the view generation rule, the query result obtained as the result of the queries that are made, in the query formats, to the databases, in response to a query that is made, in a query format, to the integrated view.

16. The database integration reference method according to claim 15, wherein
the storing includes storing a repetitive structure that is included in the tagged document and in which a same structure is repeated, and
the structuring includes, when a query is made to the database that returns the query result as the tagged document, data that is included in the repetitive structure is obtained, using the repetitive structure stored at the storing.

17. The database integration reference method according to claim 15, wherein
the storing includes storing a maximum number of appearances of elements in the view generation rule, and
the structuring includes
judging a number of appearances of elements in the tagged document; and
judging whether elements can be brought into correspondence between the databases, based on the maximum number of appearances of the elements in the view generation rule and the number of appearances.

18. The database integration reference method according to claim 15, wherein
the storing includes storing names of the elements in the tagged document and names of the elements in the databases, the elements in the tagged document being kept in correspondence with the elements in the databases by the view generation rule, and
the structuring includes receiving the query that is made to the integrated view and in which the names of the elements in the tagged document are used, and converting the names of the elements in the tagged document into the names of the elements in the databases, so that the query result is obtained as the result of the queries that are made to the databases and in which the names of the elements in the databases are used.

19. The database integration reference method according to claim 15, wherein
the storing includes storing one or more element that do not exist in the tagged document, and
the structuring includes structuring the query result obtained as the result of the queries that are made, in the query formats, to the databases, in response to the query that is made, in the query format, to the integrated view so as to include the one or more elements that do not exist in the tagged document.

20. The database integration reference method according to claim 15, wherein
the storing includes storing an instruction indicating that one or more of the elements in the tagged document should be hidden in the view generation rule, and
the structuring includes structuring, when the query result obtained as the result of the queries that are made, in the query formats, to the databases, in response to the query that is made, in the query format, to the integrated view, based on the view generation rule, the one or more of the elements in the tagged document are hidden based on the instruction.

21. The database integration reference method according to claim 15, wherein
the structuring includes structuring, when the query result obtained as the result of the queries that are made, in the query formats, to the databases, in response to the query that is made, in the query format, to the integrated view, based on the view generation rule, if there are one or more elements that are not included in the view generation rule, each of the elements that are not included is treated as a character string.

22. A database integration reference apparatus that makes it possible to reference pieces of data that are distributed in a plurality of different types of databases including a tagged document database that returns a query result as a tagged document of which a structure is predetermined, by outputting, in an integrated view, a query result obtained as a result of queries that are made, in query formats, to the databases, the database integration reference apparatus comprising:
a storage unit that stores therein a view generation rule for generating the integrated view that is defined by a correspondence relationship between elements in the tagged document and elements in the databases and a correspondence relationship among the elements in the databases; and
a processing unit that structures, based on the view generation rule present in the storage unit, the query result obtained as the result of the queries that are made, in the query formats, to the databases, in response to a query that is made, in a query format, to the integrated view.

23. The database integration reference apparatus according to claim 22, wherein
the storage unit further stores therein a repetitive structure that is included in the tagged document and in which a same structure is repeated, and
when a query is made to the database that returns the query result as the tagged document, the processing unit obtains data that is included in the repetitive structure, using the repetitive structure stored in the storage unit.

24. The database integration reference apparatus according to claim 22, wherein the storage unit further stores therein a maximum number of appearances of elements in the view generation rule, and the processing unit includes
an element appearance number judging unit that judges a number of appearances of elements in the tagged document; and
an element correspondence judging unit that judges whether elements can be brought into correspondence between the databases, based on the maximum number of appearances of the elements in the view generation rule being stored in the storage unit and the number of appearances of the elements that is judged by the element appearance number judging unit.

25. The database integration reference apparatus according to claim 22, wherein
the storage unit further stores therein names of the elements in the tagged document and names of the elements in the databases, the elements in the tagged document being kept in correspondence with the elements in the databases by the view generation rule, and
the processing unit receives the query that is made to the integrated view and in which the names of the elements in the tagged document are used, converts the names of the elements in the tagged document into the names of the elements in the databases, and obtains the query result as the result of the queries that are made to the databases and in which the names of the elements in the databases are used.

26. The database integration reference apparatus according to claim 22, wherein
the storage unit further stores therein one or more elements that do not exist in the tagged document, and
the processing unit structures the query result obtained as the result of the queries that are made, in the query formats, to the databases, in response to the query that is made, in the query format, to the integrated view, so that the query result includes the one or more elements that do not exist in the tagged document.

27. The database integration reference apparatus according to claim 22, wherein
the storage unit further stores therein an instruction indicating that one or more of the elements in the tagged document should be hidden in the view generation rule, and
when the processing unit structures, based on the view generation rule, the query result obtained as the result of the queries that are made, in the query formats, to the databases, in response to the query that is made, in the query format, to the integrated view, the processing unit hides the one or more of the elements in the tagged document based on the instruction.

28. The database integration reference apparatus according to claim 22, wherein
when the processing unit structures, based on the view generation rule, the query result obtained as the result of the queries that are made, in the query formats, to the databases, in response to the query that is made, in the query format, to the integrated view, if there are one or more elements that are not included in the view generation rule, the processing unit treats each of the elements that are not included as a character string.
